(19) United States
(12) Patent Application Publication
(10) Pub. No.: US 2006/0136949 A1
(43) Pub. Date: Jun. 22, 2006

(54) Disc apparatus

(75) Inventor: Taku Sato, Kodaira-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC Corporation

(21) Appl. No.: 11/280,961

(22) Filed: Nov. 16, 2005

(30) Foreign Application Priority Data
Nov. 17, 2004 (JP) 2004-332772

(51) Int. Cl. G11B 17/04

(52) U.S. Cl. 720/619

(57) ABSTRACT

In a slot-in type disc apparatus, even when a disc is inserted obliquely, its leading end is surely captured to operate the loading mechanism, the recording surface of the disc is prevented from being damaged due to defects in the mechanism, and the operability and reliability of the disc apparatus is remarkably improved. The disc apparatus comprises a disc supporting arm, in which, wherein in a disc loading operation, the disc supporting arm guides a disc into the disc apparatus by supporting a front end of the disc in a disc loading direction, and in a disc unloading operation, the disc supporting arm pushes a disc out of the disc apparatus by supporting a rear end of the disc in a disc unloading direction, and wherein a leading end of the disc supporting arm is provided with a normally upwardly biased supporting portion for supporting the disc.

### BACKGROUND OF THE INVENTION

1. Technical Field

The present invention relates to a disc apparatus which drives an optical disc (for example, CD-R/RW, DVD-R/−RW/RAM/+R/+RW, etc.), as a recording medium on which a large amount of information is recorded, in information equipment such as various computer systems.

2. Related Art

Generally, a disc apparatus built in a personal computer (hereinafter referred to as ‘PC’) or the like has a disc tray into which a disc is loaded, and this disc tray is adapted to advance and retreat. Also, a disc loaded into the disc tray is driven into a main body of the disc apparatus to record or reproduce information.

On the other hand, as another type of disc apparatus that does not use a disc tray, a so-called slot-in type disc apparatus is also frequently employed. This type of disc apparatus is suitable to make PCs slim and small. Since the slot-in type disc apparatus does not use a disc tray for loading or unloading a disc into or from a main body of the apparatus, when an operator inserts over half of a disc into a slot, a loading mechanism of the main body is then operated to load the disc automatically.

FIGS. 49 and 50 show the configuration and operation aspects of a loading mechanism in a conventional slot-in type disc apparatus. In the configuration shown in these drawings, when an operator inserts a disc D, the disc D reaches the position shown in FIG. 49 while its height direction and left right positions are regulated by a pin 100a and left and right guide members 101 and 102 at a leading end of a first rocking body 100, and a pin 103a at a leading end of a second rocking body 103 in the middle of the loading.

At this time, the first rock body 100 rotates in the direction of an arrow 100A by the pin 100a at its leading end being pushed by the disc D, and the second rocking body 103 also rotates in the direction of an arrow 103A by the pin 103a at its leading end being pushed by the disc D. Then, a switch lever 104 is pushed by the end of the second rocking body 103 to rotate in the direction of an arrow 104A to actuate a detection switch 105.

When the detection switch 105 is actuated, a driving means 106 is started to initiate the movement of a first slide member 107 in the direction of an arrow 107A. Since the first slide member 107 and a second slide member 108 are connected to each other at their leading ends by a slide coupling member 109 and the slide coupling member 109 is pivotally journalled by a pivot pin 110, in synchronization with retreat of the first slide member 107, the second slide member 108 advances in the direction of an arrow 108A.

When the first slide member 107 begins to retreat in this way, in the first rocking body 100 supported in a cantilevered state by the slider member 107, a follower pin 100b is guided in the cam groove 107a of the first slide member 107. Then, the rocking body 100 rotates about a pivot pin 100c in the direction of the arrow 100B. Thereby, the pin 100a at the leading end of the rocking body 100 is conveyed conveys the disc D in the direction of the arrow 107A until it abuts on pins 111a and 111b of a disc positioning pin 111.

At this time, since the pin 103a of the second rocking body 103 rotates in the direction of the arrow 103A, the pin 103a of the rocking body 103 moves in the direction of the arrows 103A while it supports the disc D in synchronization with the pin 100a at the leading end of the first rocking body 100, and after the pin 103a has abutted on the pins 111a and 111b of the disc positioning member 111, it rotates to a position slightly away from the disc D.

Although the above description has been made of the operation aspects of the loading mechanism when the disc D is loaded into the apparatus, the loading mechanism when the disc D is unloaded to the outside of the apparatus is operated according to the operation aspects reverse to the aforementioned ones. Specifically, as shown in FIG. 50, when the disc D is located in place within the apparatus, and the driving means 106 is started in the reverse direction on the basis of unloading instructions, the first slide member 107 begins to advance in the direction of the arrow 107B, and the second slide member 108 connected to the slide coupling member 109 begins to retreat synchronously in the direction of the arrow 108B. Thereby, since the first rocking body 100 rotates in the direction of the arrow 100A and the second rocking body 103 rotates in the direction of the arrow 103B, the disc D is unloaded to the outside of the apparatus while it is supported by the pins 100a and 103 at the respective leading ends of the rocking bodies.

In addition, the disc D loaded into the apparatus is clamped by a clamping head 112 which moves up and down in place. The clamping head 112 is integrated with a turntable 113 fixed to a driving shaft of a spindle motor 114. The spindle motor 114 is disposed in a frame member 115 to move up and down the frame member 115 by an elevating mechanism (for example, see JP2002-117604A).

In the apparatus configured as such, in the standby state for loading of a disc, the first rocking body 103 advances to a transverse position of the turntable 113 so that a front end of the disc D inserted and approached by an operator is received by the pin 103a. Then, as previously described, the detection switch 105 is actuated by approach of the disc D to automatically load the disc D.

Meanwhile, in the initial operation for loading such a disc D, when an operator inserts the disc D into the apparatus horizontally, the front end of the disc D abuts on the pin 103a correctly so as to operate the rocking body 103. However, when the disc D is inclined, that is, its front end is inclined upwardly or downwardly, the front end of the disc D may ride over the pin 103a or may enter a portion below the rocking body 103.

In this state, the front end of the disc D cannot push the pin 103a, which makes it impossible to load the disc D because the rocking body 103 cannot be operated. If the disc D is further inserted strongly from this state, the recording surface of the disc D may be damaged or a dangerous situation may be caused.

### SUMMARY OF THE INVENTION

Therefore, the object of the present invention is to solve the above problems by respective means described below. According to one aspect of the invention, a disc apparatus comprising a disc supporting arm, wherein in a disc loading operation, the disc supporting arm guides a disc into the disc apparatus by supporting a front end of the disc in a disc loading direction, and in a disc unloading operation, the disc supporting arm pushes a disc out of the disc apparatus by supporting a rear end of the disc in a disc unloading direction, and wherein a leading end of the disc supporting arm is provided with a normally upwardly biased supporting portion for supporting the disc.

Preferably, a scooping surface for guiding the disc may be formed at the leading end of the supporting portion.

Preferably, as the disc supporting arm rocks, the leading end of the disc supporting arm may move up and down.

Preferably, when the disc supporting arm is in a standby state for loading the disc, the leading end of the disc supporting arm may descend by a reaction against a biasing force of the supporting portion.

According to the slot-in type disc apparatus embodying the present invention, even when a disc is inserted obliquely, its front end is surely captured to operate the loading mechanism, the recording surface of the disc can be prevented from being damaged due to defects in the mechanism, and the operability and reliability of the disc apparatus can be remarkably improved.

### BRIEF DESCRIPTION OF THE DRAWINGS

FIG. 1 is a perspective view showing the appearance of a disc apparatus embodying the present invention;

FIG. 2 is a plan view showing the internal structure of the disc apparatus in FIG. 1;

FIG. 3 is a perspective view showing the internal structure of the disc apparatus in FIG. 1;

FIG. 4 is a view showing the internal structure of the bottom of the disc apparatus in FIG. 1;

FIG. 5 is a plan view showing internal mechanism elements of the disc apparatus in FIG. 1;

FIG. 6 is an exploded perspective view for explaining the configuration of a driving mechanism C;

FIG. 7 is a view for explaining a loading gear unit.

FIG. 8 is a view for explaining an operating state of the loading gear unit;

FIG. 9 is a perspective view showing the configuration of a rack gear;

FIG. 10 is a view showing a first step of the operation of an elevating mechanism;

FIG. 11 is a view showing a second step of the operation of the elevating mechanism;

FIG. 12 is a view showing a third step of the operation of the elevating mechanism;

FIG. 13 is a view showing a fourth step of the operation of the elevating mechanism;

FIG. 14 is a view showing a fifth step of the operation of the elevating mechanism;

FIG. 15 is a view showing a sixth step of the operation of the elevating mechanism;

FIG. 16 is a view showing a seventh step of the operation of the elevating mechanism;

FIG. 17 is a view showing an outward course in the elevating operation of a clamping head;

FIG. 18 is a view showing a homeward course in the elevating operation of the clamping head;

FIG. 19 is an exploded perspective view showing the configuration of a disc supporting arm of the present invention;

FIG. 20 is a sectional view showing essential parts of the disc supporting arm of the present invention;

FIG. 21 is an assembled perspective view of the disc supporting arm of the present invention;

FIG. 22 is a perspective view showing the configuration of a base of the disc supporting arm of the present invention;

FIG. 23 is a view showing a first step of the operation of the disc supporting arm;

FIG. 24 is a view showing a second step of the operation of the disc supporting arm;

FIG. 25 is a view showing a third step of the operation of the disc supporting arm;

FIG. 26 is a view showing a fourth step of the operation of the disc supporting arm;

FIG. 27 is a view showing a fifth step of the operation of the disc supporting arm;

FIG. 28 is a view showing a sixth step of the operation of the disc supporting arm;

FIG. 29 is a view illustrating an operating state of the disc supporting arm during unloading;

FIG. 30 is an exploded perspective view showing the configuration of an actuating mechanism for a guide arm;

FIG. 31 is an exploded perspective view of a lever arm.

FIG. 32 is an assembled perspective view of the lever arm;

FIG. 33 is a view showing a first step of the operation of the guide arm;

FIG. 34 is a view showing a second step of the operation of the guide arm;

FIG. 35 is a view showing a third step of the operation of the guide arm;

FIG. 36 is a view showing a fourth step of the operation of the guide arm;

FIG. 37 is a view showing a fifth step of the operation of the guide arm;

FIG. 38 is a view showing a first step of disc loading.

FIG. 39 is a view showing a second step of disc loading;

FIG. 40 is a view showing a third step of disc loading;

FIG. 41 is a view showing a fourth step of disc loading;

FIG. 42 is a view showing a fifth step of disc loading;

FIG. 43 is a view showing an assembled state of the disc supporting arm of the present invention;

FIG. 44 is a view for explaining the functional configuration of the disc supporting arm of the present invention;

FIG. 45 is a view for explaining the functional configuration of the disc supporting arm of the present invention;

FIG. 46 is a view showing an actuating state of the disc supporting arm of the present invention;

FIG. 47 is a view showing an actuating state of the disc supporting arm of the present invention;

FIG. 48 is a view showing an actuating state of the disc supporting arm of the present invention;

FIG. 49 is a view for explaining the configuration of a conventional disc supporting arm; and

FIG. 50 is a view for explaining the configuration of a conventional disc supporting arm.

### DESCRIPTION OF THE EMBODIMENTS

Hereinafter, embodiments of the present invention will be described with reference to the accompanying drawings. In order to facilitate understanding of the present invention, the outline of the overall configuration will be described together.

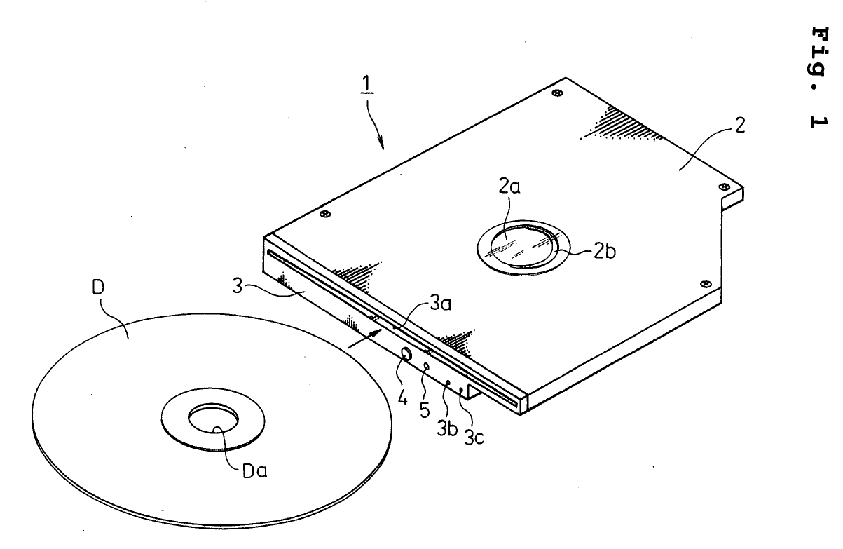

FIG. 1 is a view showing the appearance of a slot-in type disc apparatus 1 embodying the present invention. An opening 2a is formed at the center of a top plate of a chassis case 2 constructed in its shielded state, and an inwardly protruding protrusion 2b is formed at a circumferential edge of the opening 2a. A bezel 3 is fixed to a front end of the chassis case 2, and the bezel 3 is formed with a slot 3a for allowing a disc D to be inserted thereinto, and through-holes 3b and 3c for emergency releasing. The bezel 3 is also provided with a push button 4 for instructing unloading of the disc D received in the apparatus to the outside of the apparatus, and an indicator 5 for indicating an operating state of the disc apparatus 1.

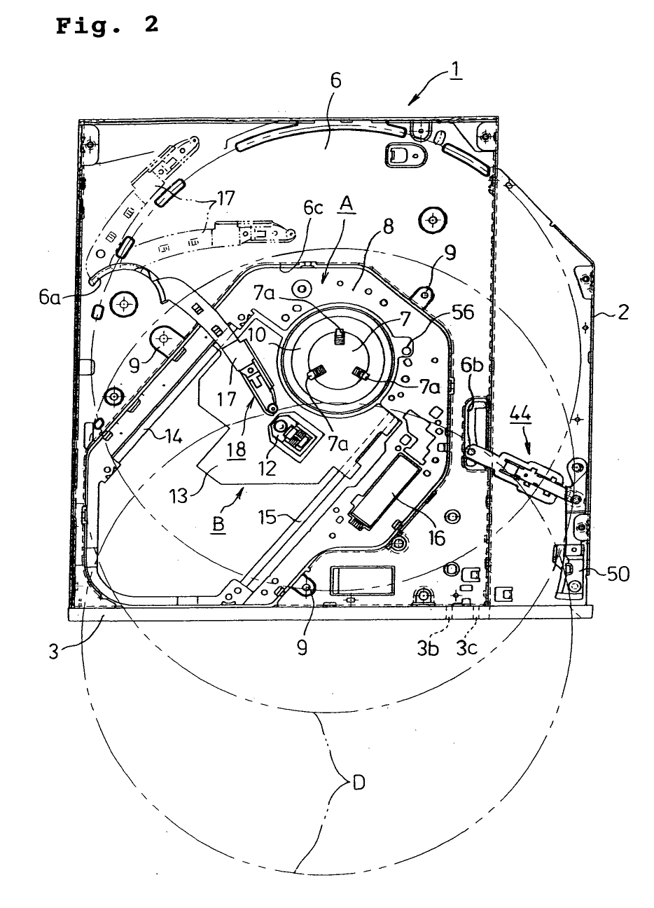

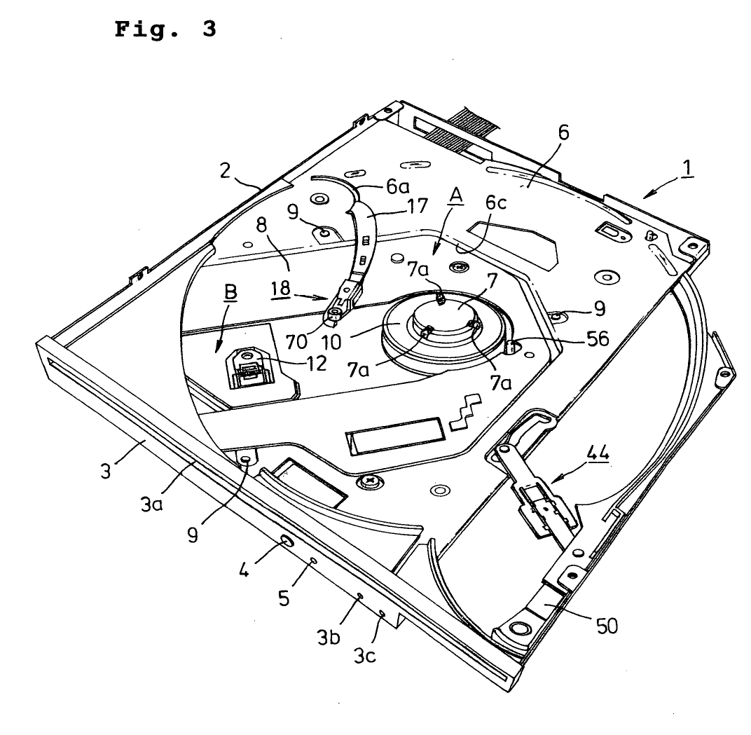

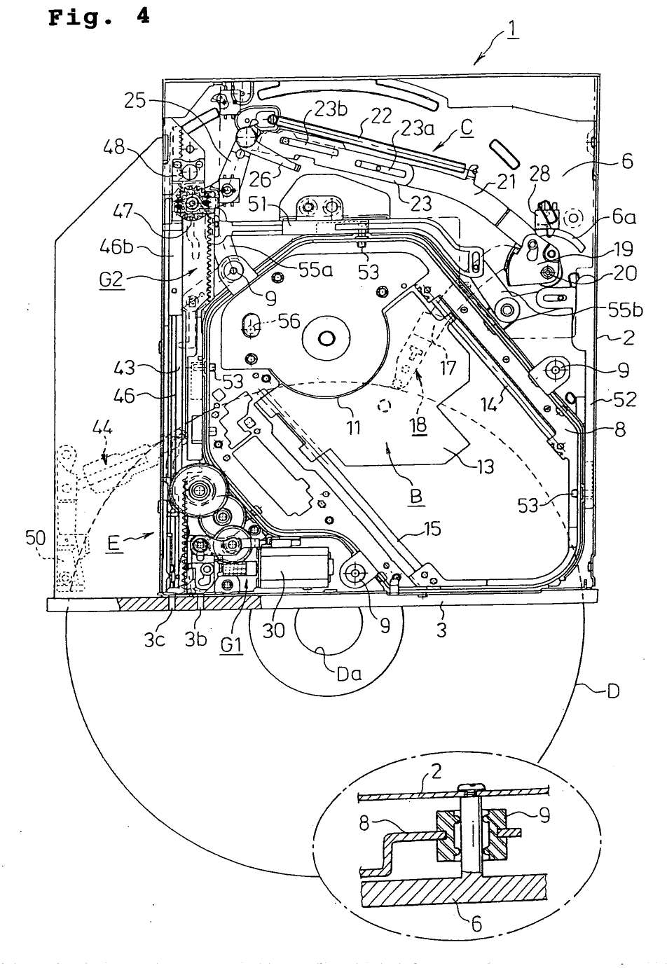

FIG. 2 is a plan view of the disc apparatus 1 with the top plate of the chassis case 2 removed, and FIG. 3 is a perspective view of FIG. 2. In these drawings, a base panel 6 is disposed within the chassis case 2, and a drive system unit A for the disc D is provided in a state where it is disposed obliquely downward from the center of the base panel 6. In the drive system unit A, a frame member 8, which is allowed to move up and down in the horizontal state, is connected to the base panel 6 at a plurality of spots (three spots in the present embodiment) by a known shock-absorbing supporting structure 9 in order to clamp a center hole Da of the disc D or release clamping of the disc D (see a cutaway view of FIG. 4). In addition, as a driving method for the frame member 8, there is a method in which one end is journalled and cantilevered and the other leading end is rocked to move a clamping head up and down, but a method of moving the frame member 8 up and down as it is in the horizontal state is adopted in the embodiment of the present invention.

The clamping head 7 is disposed at the leading end of the frame member 8 at a position corresponding to the center of the disc D after being loaded and stopped. The clamping head 7 is integrally formed with a turntable 10 and is fixed to a driving shaft of a spindle motor 11 disposed immediately below the clamping head. The spindle motor 11 drives to rotate the disc D clamped by the clamping head 7, thereby recording or reproducing information. Reference mark B indicates a head unit supported by the frame member 8. In this head unit, a carrier block 13 for reciprocating an optical pickup 12 in the radial direction of the disc D is supported by guide shafts 14 and 15 having their both ends fixed to the frame member 8, and is reciprocated by a thread motor 16 and a gear unit (not shown).

Next, a description will be made of a driving mechanism C which rocks a disc supporting arm 17 functioning to guide the disc D into the apparatus and to push out (eject) the disc D to the outside of the apparatus. In addition, a description related to the gist of the present invention, of the disc supporting arm 17 and a disc supporting portion 18 configured at the leading end of the disc supporting arm 17 will be made later.

Since the end of the disc supporting arm 17 serving as its rocking fulcrum is integrated with a supporting plate 19, as shown in FIG. 4, at the rear of the base panel 6, and the supporting plate 19 is adapted to be turnable by a pivot pin 20, the disc supporting arm 17 on the base panel 6 rocks in a range of the slit 6a with turning of the supporting plate 19.

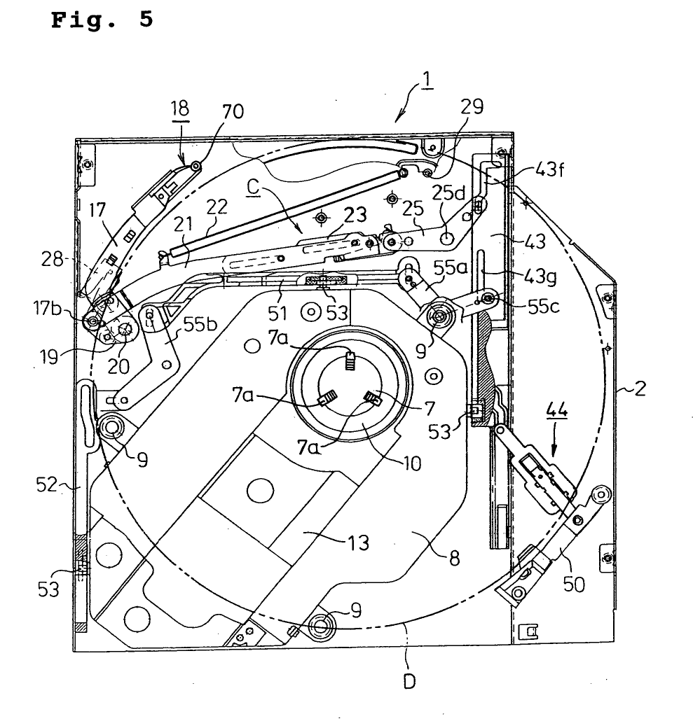

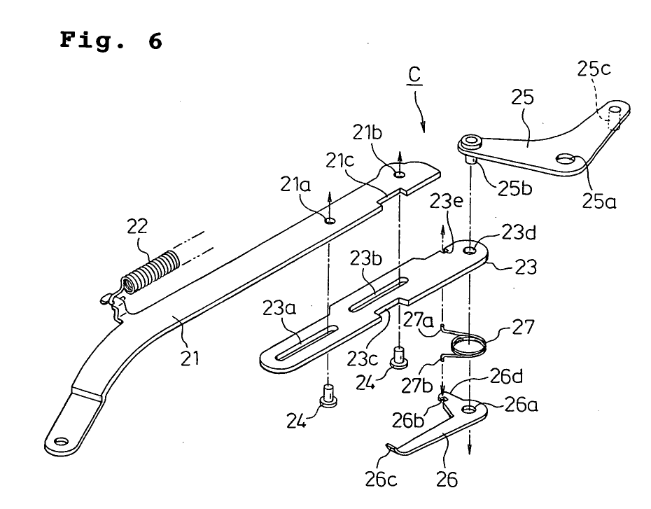

FIG. 5 is a plan view showing a configuration including the driving mechanism C for the disc supporting arm 17 in a state where the base panel 6 is removed, in which a first link arm 21, which directly drives the disc supporting arm 17, is connected by a pivot pin 17b of the supporting plate 19, and is always biased by a tension coil spring 22. On the other hand, as shown in FIG. 6, a second link arm 23 is formed with slits 23a and 23b. Rivet pins 24 are inserted through the slits 23a and 23b, and its leading ends are fixed to through-holes 21a and 21b of the first link arm 21. The first link arm 21 and the second link arm 23 are extendably integrated in a range of the slits 23a and 23b. In addition, the first link arm 21 and the second link arm 23 are formed with a cutout portions 21c and 23c on which a locking mechanism to be described below actuates.

Reference numeral 25 indicates a lever arm for transmitting a driving force to the second link arm 23. A through-hole 25a serving as a fulcrum is pivotally supported by a pivot pin 25d. A pivot pin 25b is fixed to an actuating end of the lever arm 25, and the pivot pin 25b is inserted through the through-hole 23d of the second link arm 23 and a through-hole 26a of a locking lever 26. Also, a torsion coil spring 27 is disposed between the second link arm 23 and the locking lever 26, its one end 27a is locked to a recessed portion 23e of the second link arm 23 and its other end 27b is locked to a recessed portion 26b of the locking lever 26.

Thereby, a locking end 26c of the locking lever 26 is biased in a direction that it engages the cutout portion 21c of the first link arm 21 and the cutout portion 23c of the second link arm 23. In addition, a starting pin 29 is disposed at the rear of the base panel 6. The starting pin 29 pushes a limit switch 28 to be operated by a trailing end of the first link arm 21 when the first link arm 21 has reached a predetermined position, and pushes a trailing end 26d of the locking lever 26 when the second link arm 23 has reached a predetermined position.

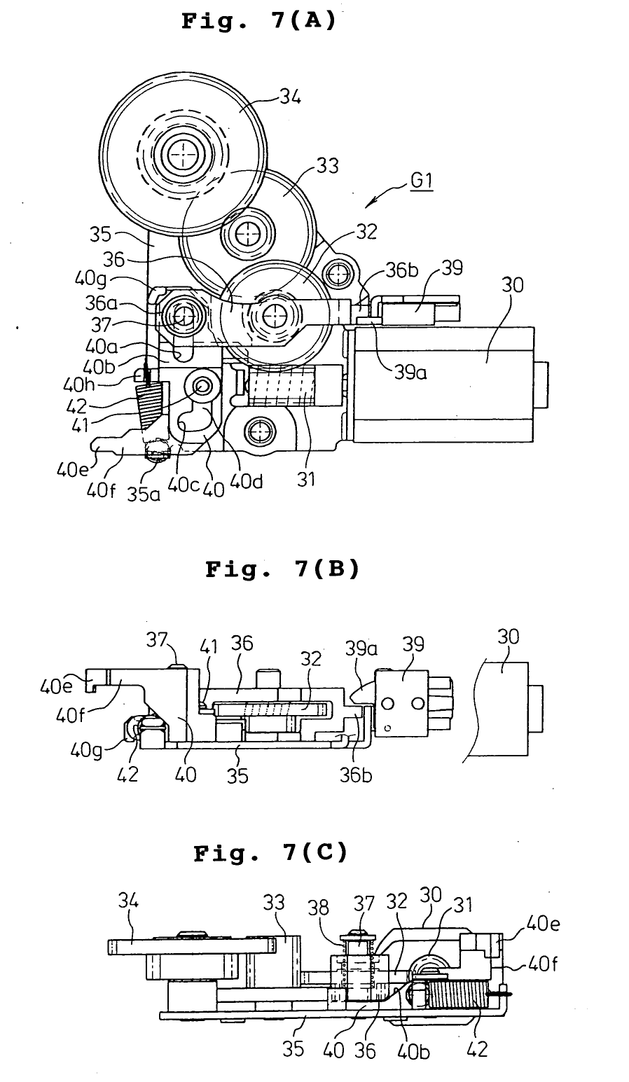

Next, the configuration of a slider mechanism and a conveyance mechanism E serving as power transmission elements for transmitting power to the driving mechanism C of the disc supporting frame 17 will be described. First, the conveyance mechanism E is generally configured by a combination of a loading gear unit G1 and a rack gear unit G2. FIGS. 7 and 8 are views for explaining the configuration and operating state of the loading gear unit G1. In these drawings, reference numeral 30 indicates a loading motor serving as a power source. A worm gear 31 is fixed to an output shaft of the loading motor 30 so as to rotate coaxially therewith. A gear train is configured such that a torque of the worm gear 31 is sequentially transmitted to double gears 32, 33 and 34 journalled to a gear base 35, i.e., from a small-diameter gear to a large-diameter gear while being reduced.

In the above configuration of gears, the double gear 32 has a release mechanism which releases a engagement state with the worm gear 31. This causes an end 36a of a holder 36 capable of sliding vertically while holding the double gear 32 to be inserted around a pivot pin 37 and to be biased downwardly and journalled by a compression coil spring 38. Thereby, in a normal state, the worm gear 31 and the double gear 32 become a normally engagement state as shown in FIG. 7C. In addition, an end of the holder 36 at the loading motor 30 is formed with a dog head 36 which enables a knob 39a of a limit switch 39 fixed to the gear base 35 to be actuated.

The undersurface of the end 36a of the holder 36 is provided with a slider member 40 journalled coaxially with the pivot pin 37. A portion of the slider member 40 journalled to the pivot pin 37 is formed with an elongate groove 40a which enables the slider member 40 to slide in a direction perpendicular to the end 36a of the holder 36. In addition, the slider member 40 has a slope 40b formed between its front and rear ends. When the slider member 40 is advanced, the slope 40b pushes up the end 36a of the holder 36 from the bottom to raise the entire holder 36.

The rear end of the slider member 40 is formed with an elongate groove 40d having a locking stepped portion 40c journalled to a pivot pin 41, and the rear end thereof is also formed with an actuating piece 40f having a sealing projection 40e. On the other hand, the front end of the slider member 40 is formed with a reset piece 40g which is started according to movement of the rack gear unit G2.

In the slider member 40 integrally configured as such, a tension coil spring 42 is provided in a tensioned state at an inclined angle for imparting a torque between a rack piece 40h of the slider member and a rack piece 35a of the gear base 35 to bias the slider member 40 so that the slider member 40 rotates counterclockwise while it normally retreats.

By configuring the slider member 40 as described above, in the normal state shown in FIG. 7, the slider member 40 uses the pivot pin 37 as its fulcrum. In this state, when the slider member 40 is pushed and advanced from its rear end, and the locking stepped portion 40c of the elongate groove 40d reaches the location of the pivot pin 41, the tension of the tension coil spring 42 rotates the slider member 40 about the pivot pin 37 as its fulcrum. As a result, as shown in FIG. 8, the locking stepped portion 40c and the pivot pin 41 engages each other to turn into a locked state and maintain this posture.

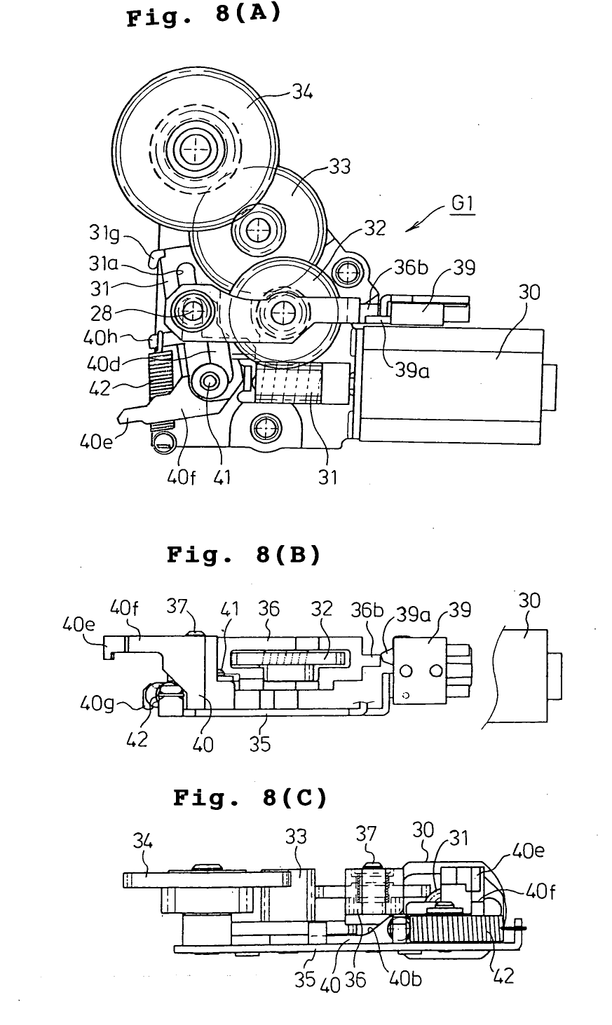

Next, in the rack gear unit G2, as shown in FIG. 9, a main rack body 43 is integrally formed with gear trains 43a and 43b. The gear train 43a engages with a small-diameter gear of the double gear 34 of the loading gear unit G1. Accordingly, the loading motor 30 is driven to advance or retreat the main rack body 43 within the chassis case 2. By advancing or retreating the main rack body 43 as such, the driving mechanism C connected to a leading end of the main rack body 43 drives to rock the disc supporting arm 17 and to rock a guide arm 50 for loading the disc D by the lever arm 44 connected to the main rack body 43 on the surface of the base panel 6 shown in FIG. 2.

On the main rack body 43 configured as such, a gear member 45 which advances and retreats at the leading end of the main rack body 43 is disposed in a floating state, and a push pin 46 having blocks 46a and 46b at its front and rear is disposed for pushing to advance the gear member 45. Also, the gear train 43b and the gear member 45 are caused to engage and connect with a double gear 47 attached to a gear frame 48 so as to rotate freely. In this case, a large-diameter gear 47a of the double gear 47 is adapted to engage with a rear end of the gear train 43b, and its small-diameter gear 47b is adapted to engage with a leading end of the gear member 45 integrally formed with the block 46b.

Accordingly, when the gear member 45 is pushed by an external force through the push pin 46, since the double gear 47 rotates in place, the torque of the large-diameter gear 47a is transmitted to the gear train 43b to move the main rack body 43. In addition, reference numeral 49 indicates an actuating piece which pushes the reset piece 40g formed at the front end of the slider member 40 of the loading gear unit G1. When the actuating piece 49 pushes the reset piece 40g of the slider member 40 in the state shown in FIG. 8, the loading gear unit G1 returns to the state shown in FIG. 7 since the engagement between the pivot pin 41 and the locking stepped portion 40c is released.

Next, the configuration and operation aspect of an elevating mechanism for the frame member 8 will be described. This elevating mechanism is composed of the main rack body 43, slide members 51 and 52 which advances or retreats in synchronization with the main rack body 43, and a follower pin 53 guided within a cam groove defined by the main rack body 43 and the slide members 51 and 52. The slide member 51 is connected to the main rack body 43 of by a link member 55a, and the slide member 51 is connected to the slide member 52 by the link member 55b. This causes the main rack body 43 and the slide members 51 and 52 to advance or retreat in synchronization with each other.

Follower pins 53 fixed to the frame member 8 are arranged such that their releasing ends engage cam grooves, respectively, which are formed in the main rack body 43 and the slide members 51 and 52. Since the engagement relations between the follower pins 53 and the respective cam grooves are nearly common to each other, the engagement relation between the cam groove of the main rack body 43 and the corresponding follower pin 53 will be described below as a typical example.

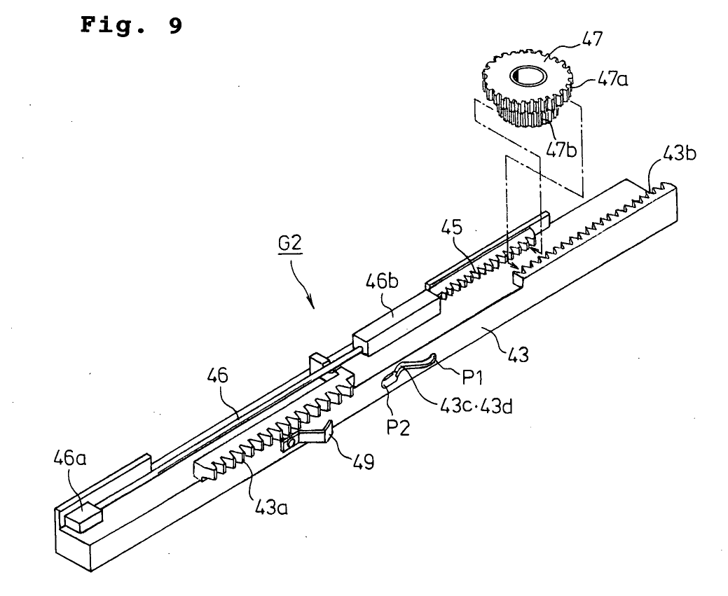

First, in the embodiment shown in FIGS. 10 to 16, the follower pin 53 fixed to the frame member 8 is mounted with an elastic ring 54 with flexibility. On the other hand, the cam groove formed in the main rack body 43 is formed to become a double cam structure of a cam groove 43c for allowing the follower pin 53 to be guided in sliding contact therewith, and a cam groove 43d into which the elastic ring 54 is fitted loosely such that it does not contact the cam groove while the follower pin 53 is guided by the cam groove 43c.

In a higher portion P2 of the cam grooves 43c and 43d, the cam groove 43d to retain the elastic ring 54 is formed to have almost the same diameter as that of the elastic ring 54, and the cam groove 43c is ended in the vicinity of the entrance of the higher portion P2 and is opened to the higher portion P2. Accordingly, within the range of formation of the cam groove 43c, the follower pin 53 is regulated and supported by the cam groove 43c, and when the follower pin 53 reaches the higher portion P2, it is supported via the elastic ring 54.

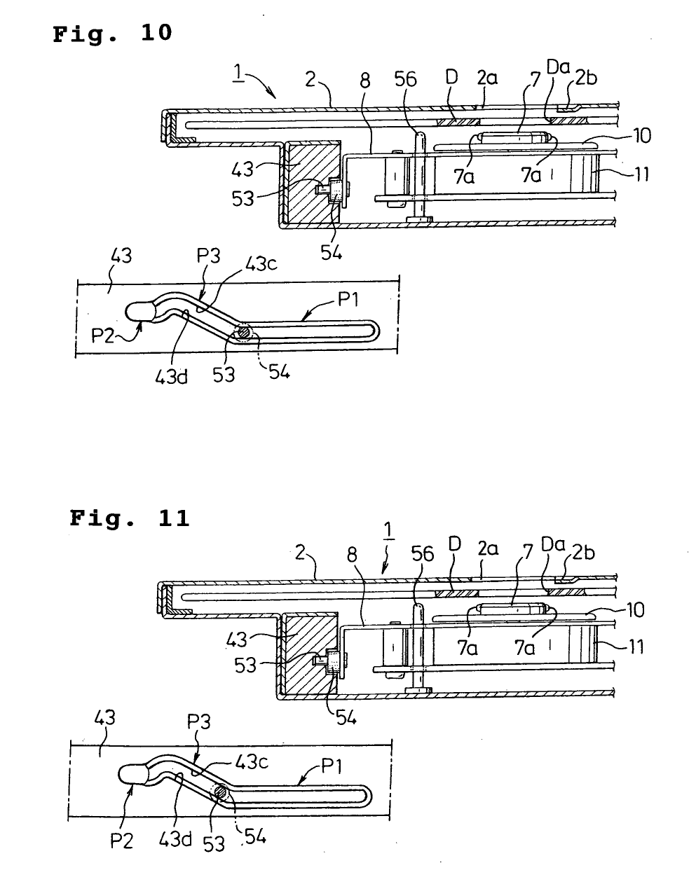

Next, operation aspects of the elevating mechanism for the frame member 8 configured as described above will be described based on the steps shown in FIGS. 10 to 16. FIG. 10 shows an earliest state in which the disc D is loaded into the disc apparatus 1 and is stopped at a position where the center hole Da of the disc D directly faces the clamping head 7. In this state, since the follower pin 53 is at a lower portion P1 of the cam groove 43c, the frame member 8 descends to a lowest position and the clamping head 7 is in a standby state for ascending. When the main rack body 43 begins to further retreat from this state, as shown in FIG. 11, the follower pin 53 is guided to an oblique portion P3 of the cam groove 43c to ascend gradually, and thereby, the frame member 8 and clamping head 7 also begin to ascend.

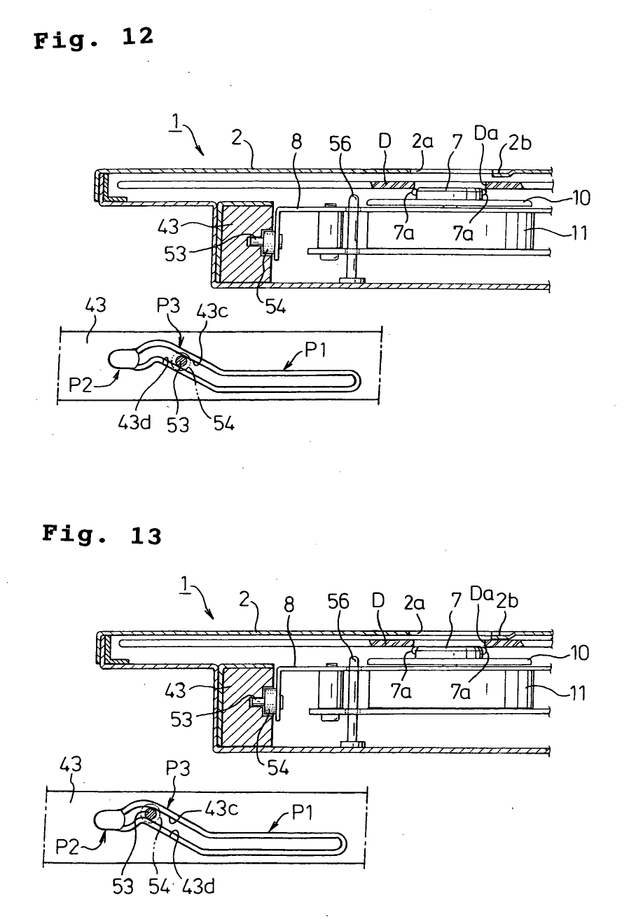

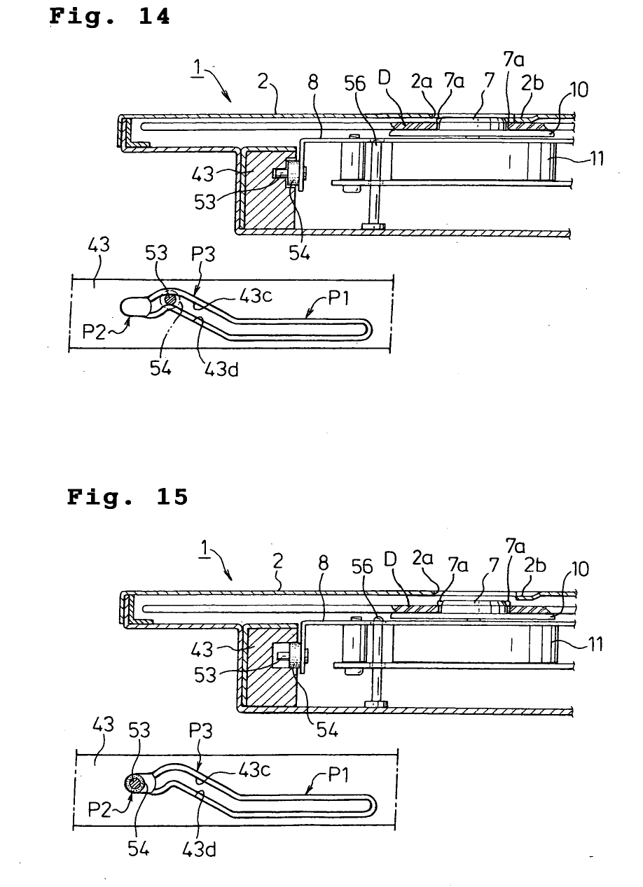

Then, when the follower pin 53 being guided by the cam groove 43c further ascends along the oblique portion P3 as shown in FIG. 12, a checking claw 7a of the clamping head 7 abuts on an opening end of the center hole Da of the disc D. When the clamping head 7 ascends as shown in FIG. 13 from this state, the checking claw 7a pushes up the disc D to push the opening end of the center hole Da against a protrusion 2b of the opening 2a of the chassis case 2. Further, when the follower pin 53 is guided to reach an apex of the cam groove 43c as shown in FIG. 14, the clamping head 7 is fitted into the center hole Da of the disc D, and the checking claw 7a is locked to the end of the center hole Da of the disc D to fix the disc D onto the turntable 10, thereby completing the clamping.

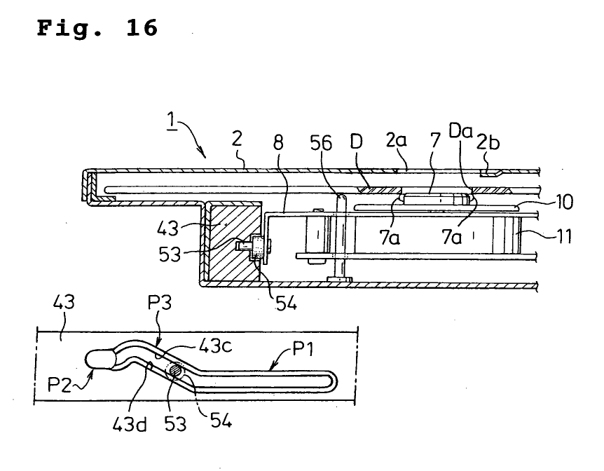

When the main rack body 43 further retreats from the state in FIG. 14, the frame member 8 descends, and as shown in FIG. 15, the elastic ring 54 fits into the higher portion P2. In this way, the follower pin 53 departs from the cam groove 43c to be released from the regulation and support by the cam groove 43c, and the follower pin 53 is elastically supported by the elastic ring 54, thereby generating a shock-absorbing effect for the frame member 8.

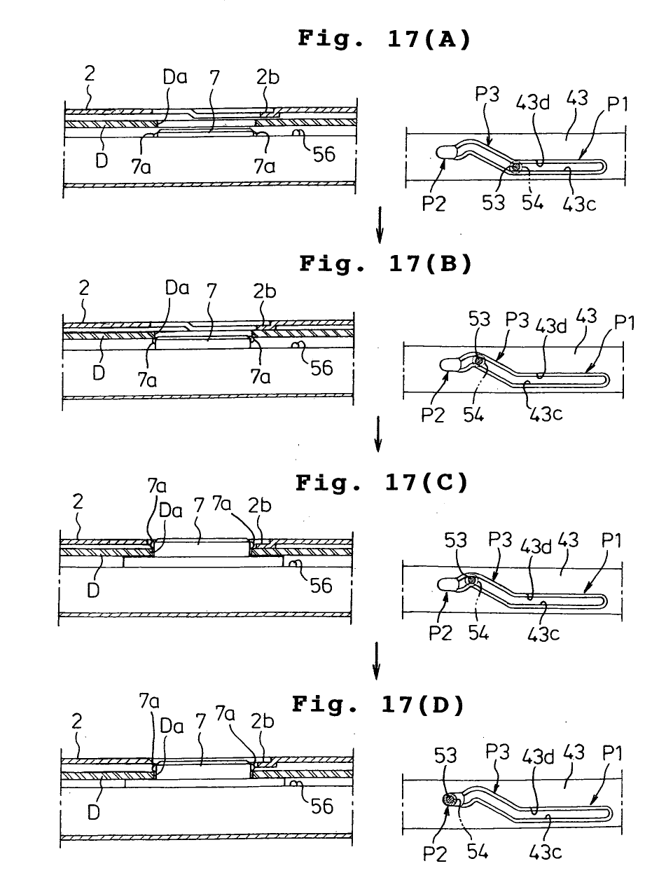

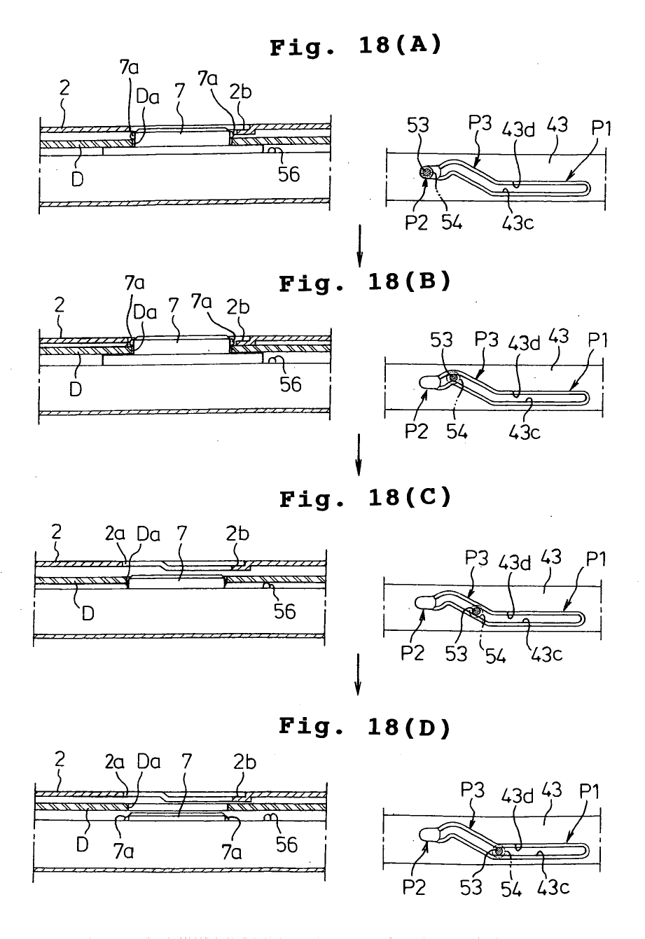

FIG. 16 shows the process of unloading the disc D. As can be seen from this drawing, while the main rack body 43 is advanced to make the follower pin 53 reach the lower portion P1 through the steps reverse to the above-mentioned ones, a clamping releasing pin 56 enables the disc D to depart form the clamping head 7 to be unloaded to the outside of the apparatus. In order to facilitate understanding the operation aspects described above, the process of clamping the disc D and the process of releasing clamping of the disc D are shown in succession in FIG. 17 and FIG. 18, respectively.

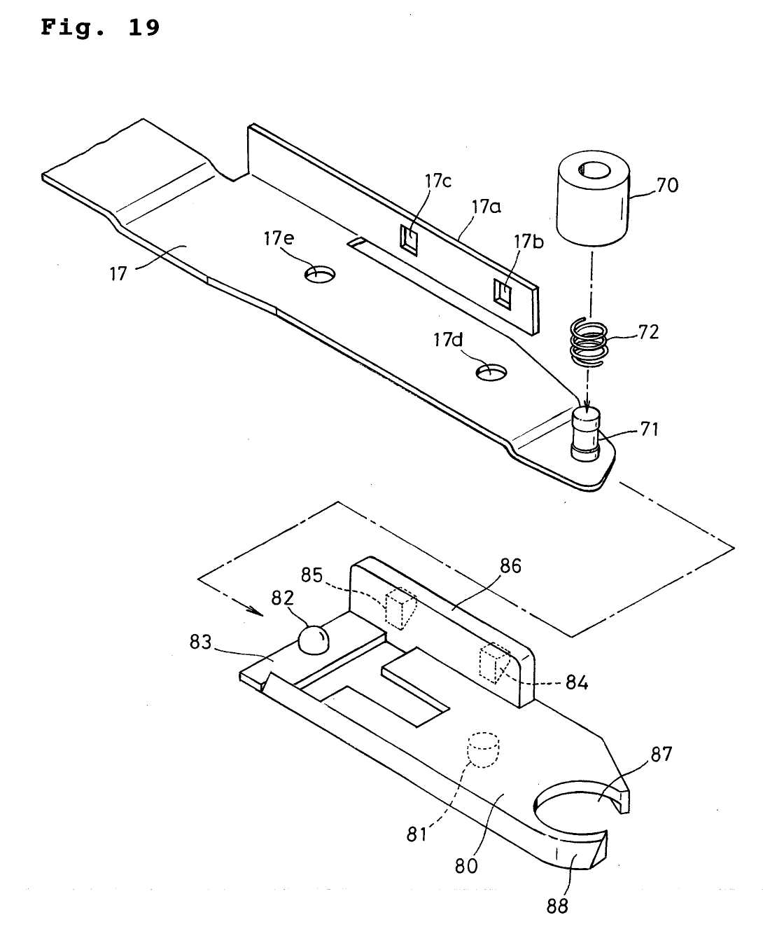

Next, the specific configuration of the disc supporting arm 17 and the disc supporting portion 18 and operation aspects of the disc supporting arm will be described. As shown in FIG. 19, the disc supporting arm 17 is formed, at its leading end, with an upright piece 17a which supports a holder 80 and it is formed with perforations 17b, 17c, 17d and 17e for fixing the holder 80. Also, a base end of the pin 71 for journaling a supporting roller 70 is fixed to the foremost end of the disc supporting arm 17.

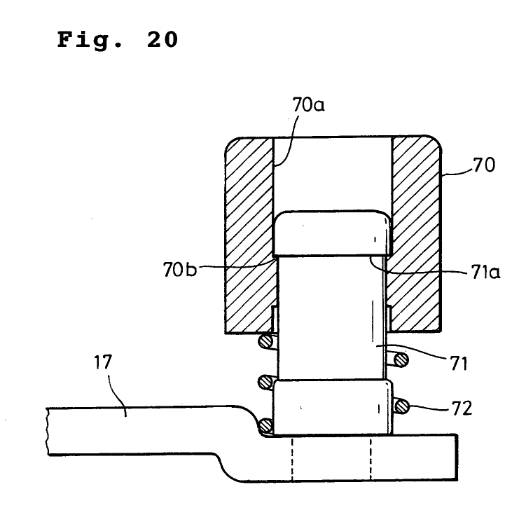

Also, as shown in FIG. 20, the supporting roller 70 is mounted such that a bottom opening of a through-hole 70a thereof is press-fitted around a head of the pin 71 and is snap-fitted thereon, and a stepped portion 70b formed on an inner circumferential surface of the supporting roller 70 and a flange 71a formed on the head of the pin 71 prevent falling off of the supporting roller 70. In this case, in order to interpose a compression coil spring 72 as shown in this drawing, the supporting roller 70 is always biased upwardly.

On the other hand, the holder 80 to be mounted on the leading end of the disc supporting arm 17 is formed with a locking projection 81 protruding to the rear surface, as shown in FIG. 19, and a beam 83 formed at the rear end of the disc supporting arm is formed with a locking projection 82 protruding to the surface. Also, a side portion of the holder corresponding to the upright piece 17a of the disc supporting arm 17 is formed with an upright wall 86 having locking projections 84 and 85 formed thereon. In addition, the leading end of the holder 80 is formed with an opening 87 for allowing sinking of a bottom portion of the supporting roller 70, and a scooping surface 88 with a rising gradient is formed from the leading end of the opening 87 to the side portion thereof.

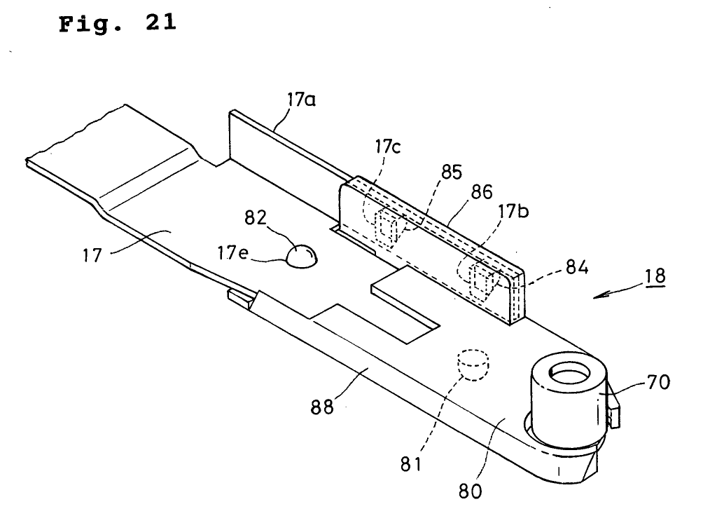

When the leading end of the disc supporting arm 17 is inserted from the beam 83 of the holder 80 configured as such, the locking projections 81 and 82 of the holder 80 engage the perforations 17d and 17e of the disc supporting arm 17, respectively, and the locking projections 84 and 85 of the upright wall 86 of the disc supporting portion 18 engage the perforations 17b and 17c, respectively, of the upright piece 17a of the disc supporting arm 17, so that the disc supporting arm 17 and the holder 80 are integrated into one, as shown in FIG. 21.

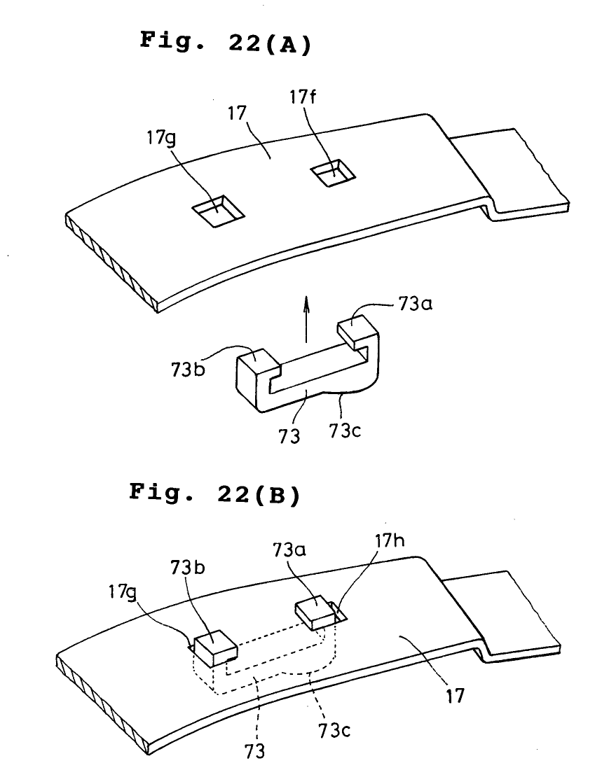

The rear end of the disc supporting arm 17 is formed with perforations 17f and 17g, as shown in FIG. 22A, and supporting legs 73a and 73b of the slider 73 formed with a slope 73c are locked in the perforations 17f and 17g, respectively, so that the slider 73 is fixed to the rear face of the disc supporting arm 17, as shown in FIG. 22B.

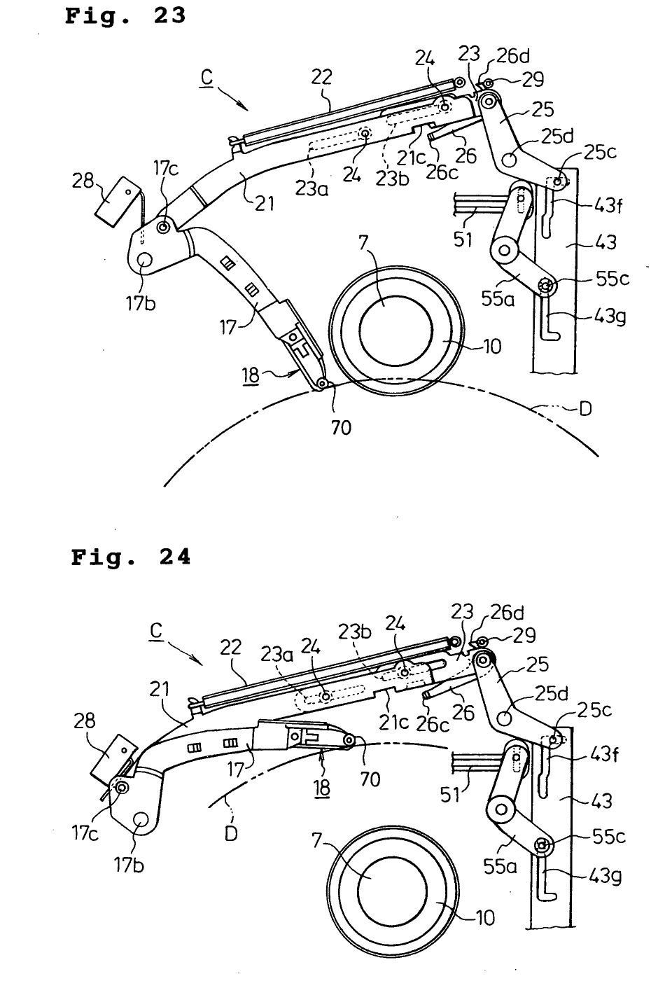

Next, the configuration and operation aspect of the disc supporting arm 17 as such will be described. The driving mechanism C for driving the disc supporting arm 17 is formed by assembling the mechanism elements shown in FIG. 6, but its operation is performed with advancement and retreat of the main rack body 43. Specifically, referring to FIG. 23, a follower pin 25c fixed to an end of the lever arm 25 is mounted on a guide groove 43f formed in the main rack body 43 so as to be guided by the guide groove 43f. The state shown in FIGG. 23 represents an initial state that, after an operator inserts the disc D through the slot 3a, the front end of the disc abuts on the supporting roller 70 of the disc supporting portion 18 at the leading end of the disc supporting arm 17. At this time, the leading end 26d of a locking lever 26 is pushed up against a starting pin 29, therefore, the locking end 26c is not interposed between the cutout portions 21c and 23c of the first and second link arms 21 and 23.

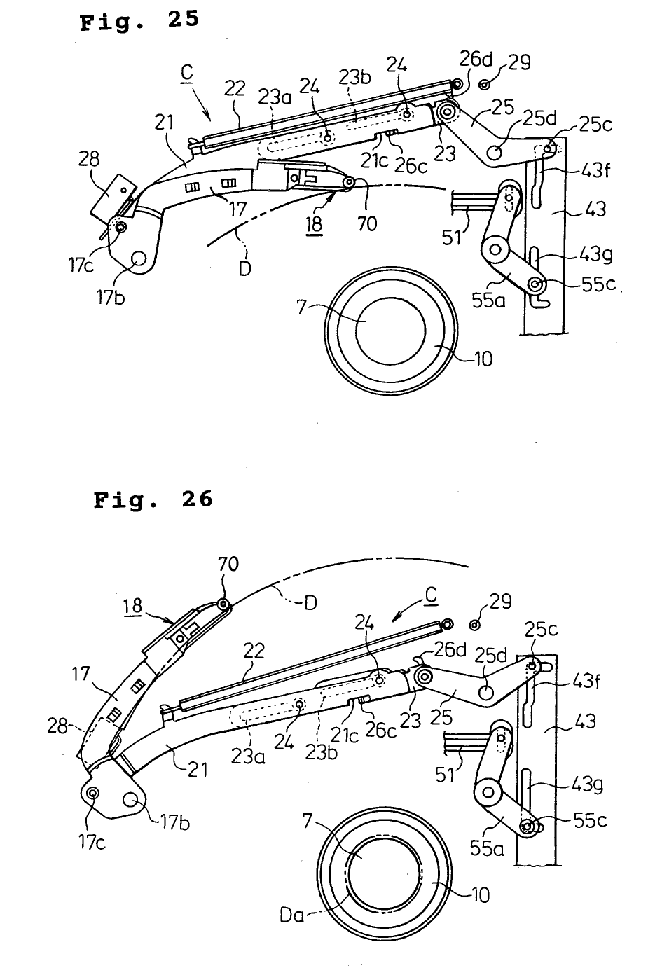

FIG. 24 shows a state in which an operator further pushes the disc D into the apparatus. In this state, the disc supporting arm 17 rocks rearwardly to draw the first link arm 21 connected to the base end of the disc supporting arm 17 by the pivot pin 17c to actuate the limit switch 28. At this time, since the lever arm 25 is connected to the stationary main rack body 43, the second link arm 23 connected to the lever arm is kept in place. Accordingly, the first link arm 21 is in an unlocked state to the second link arm 23, and as shown in FIG. 24, the first link arm 21 slides on the second link arm 23 into an extended state.

FIG. 25 shows a state in which the conveyance mechanism E starts driving based on signals from the limit switch 28 actuated as above and the main rack body 43 retreats. In this state, with the retreat of the main rack body 43, the lever arm 25 is rocked by the guide groove 43f, and the second link arm 23 slidingly advances so as to follow the first link arm 21. Therefore, the locking end 26c of the locking lever 26 released from the pushing by the starting pin 29 is interposed between the cutout portions 21c and 23c of the first and second link arms 21 and 23 to integrate the first and second link arms 21 and 23 into a locked state. That is, during loading of the disc D, the first and second link arms 21 and 23 are first displaced in the direction that they extend (from the state in FIG. 23 to the state in FIG. 24), and then displaced in the direction that they retract (from the state in FIG. 24 to the state in FIG. 25), thereby locking the first and second link arms 21 and 23.

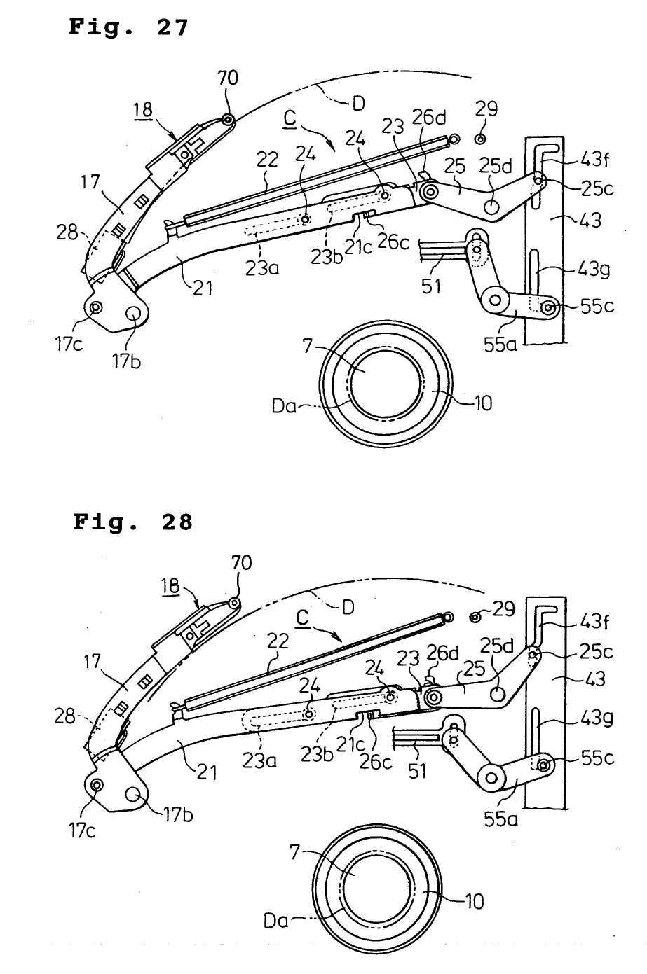

FIG. 26 shows a state in which further retreat of the main rack body 43 causes the disc supporting arm 17 to load the rearwardly rocked disc D, and the center hole Da of the disc D to coincide with the clamping head 7. Up to this point of time, the disc D is retained by the disc supporting portion 18 and the guide arm 50, and the disc supporting arm 17 and the guide arm 50 rocks in synchronization with each other. Also, up to this point of time, a follower pin 55c of the link member 55a simply slides within the guide groove 43g of the main rack body 43 and does not receive an action resulting from the retreat of the main rack body 43.

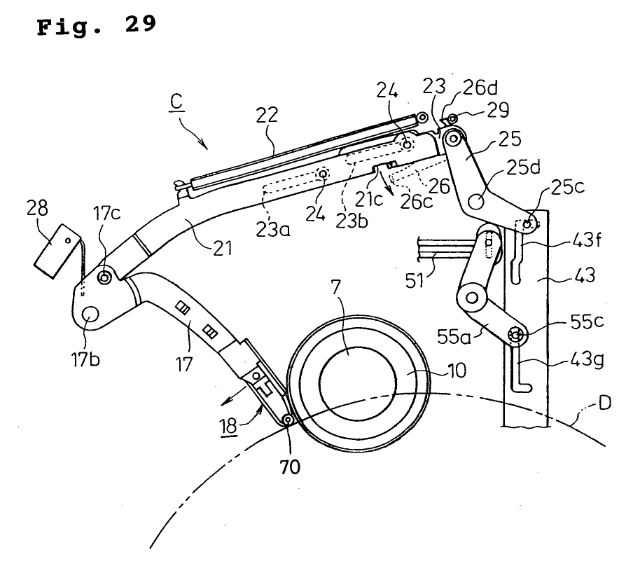

Since the follower pin 25c of the lever arm 25 simply slides in a longitudinal groove portion of the guide groove 43f of the main rack body 43 in the course of FIGS. 26 and 27, the disc supporting arm 17 is kept in place. On the other hand, since the follower pin 55c of the link member 55a is pushed up in a transverse groove portion of the guide groove 43g of the main rack body 43, the slide members 51 and 52 slide with the main rack body 43 in the course of FIGS. 26 and 27, and the elevating mechanism of the frame member 8 is operated to allow the clamping head 7 to clamp the center hole Da of the disc D at the point of time shown in FIG. 27.

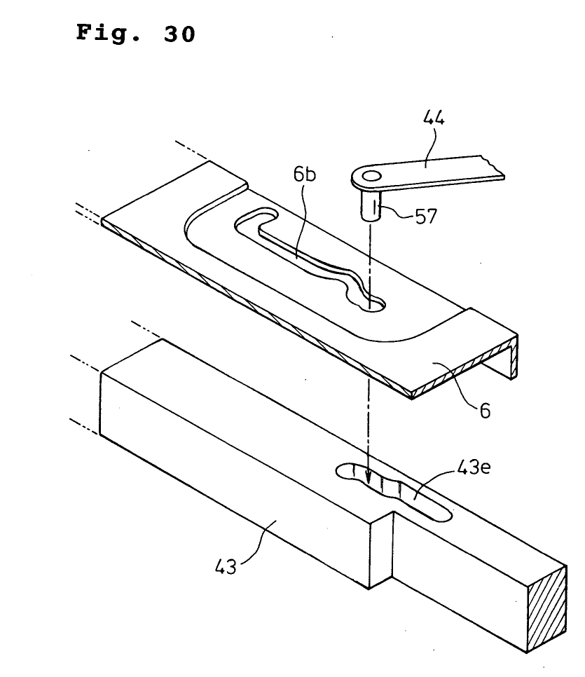

FIG. 28 shows a state in which the main rack body 43 slightly retreats after the clamping head 7 has clamped the center hole Da of the disc D. In this state, since the lever arm 25 rocks slightly in a longitudinal end of the longitudinal groove of the guide groove 43 of the main rack body 43f, and as shown in FIG. 27, the disc supporting arm 17 also rocks slightly, the retainment of the disc D by the disc supporting portion 18 is released. At this point of time, the guide arm 50 also rocks slightly and synchronously to release retainment of the disc D. Also, in the elevating mechanism for the frame member 8, the follower pin 53 descends slightly within the cam groove 43c, thereby enabling the disc D to be rotatingly driven.

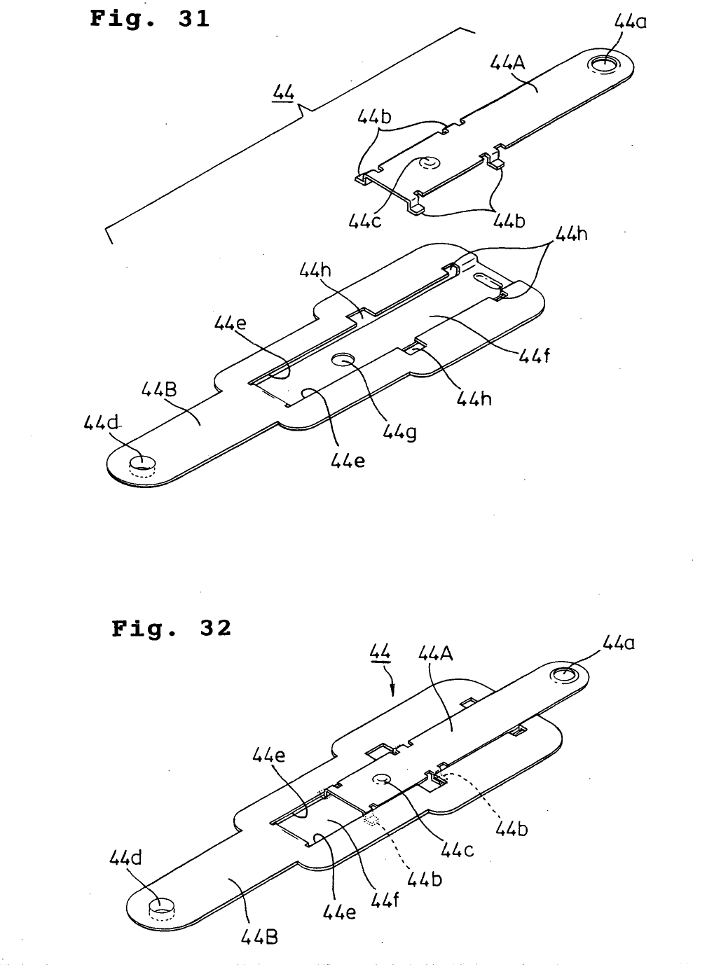

The above description has been made of the operation aspects of the elevating mechanism C during the loading of the disc D, but the constitutional elements of the respective parts performs the reverse operation during unloading of the disc D through the steps reverse to the above ones. Specifically, the elevating mechanism E is reversely driven to advance the main rack body 43, so that the disc supporting arm 17 rocks forwardly from the state in FIG. 28 to the state in FIG. 25, and the trailing end 26d of the locking lever 26 abuts on the starting pin 29 in the state shown in FIG. 29. When the main rack body 43 advances further, the trailing end 26d is pushed by the starting pin 29 and thereby the locking end 26c of the locking lever 26 rocks to depart from the cutout portions 21c and 23c of the first link arm 21 and the second link arm 23, and the first link arm 21 and the second link arm 23 are released from their integrated locked state. Simultaneously, the biasing force of the tension coil spring 22 acts to rock the disc supporting arm 17 to the position shown in FIG. 23 to pop the disc D out of the slot 3a at a final moment of the final course of the unloading, thereby completing the unloading.

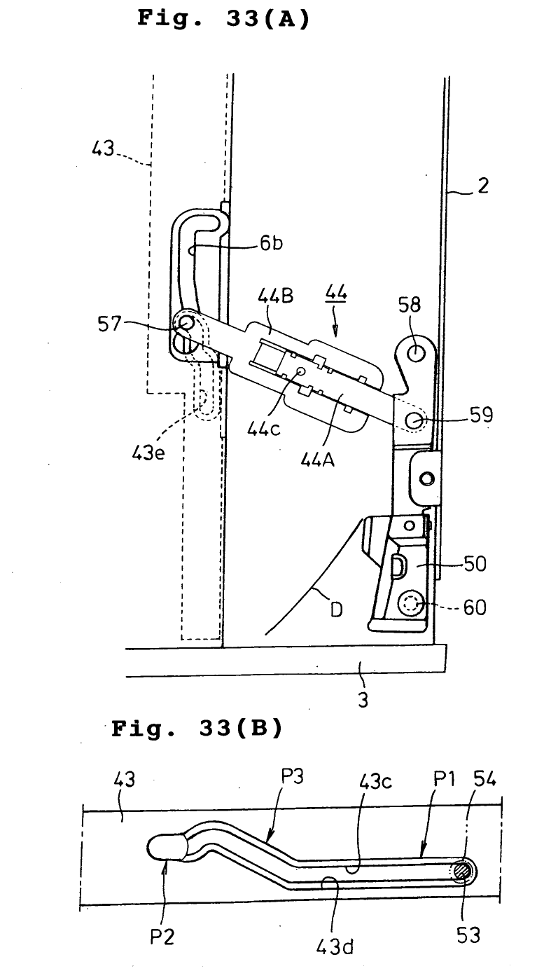

Next, the configuration and operation aspects of the guide arm 50 driven by the main rack body 43 will be described below. FIG. 30 shows the configuration in which the guide arm 50 is driven. In this configuration, a guide slit 6b is formed in a portion of the base panel 6 overlapping a guide groove 43e formed in the main rack body 43, a follower pin 57 fixed to the leading end of the lever arm 44 is inserted into the guide groove 43e and the guide slit 6b, the guide slit 6b in place interacts with the advancing or retreating guide groove 43e so as to control the operation of the follower pin 57.

As shown in FIG. 33, to a base end of the guide arm 50 rotatably supported by a pivot pin 58, the lever arm 44 is journalled by a pivot pin 59. The leading end of the guide arm 50 is formed with a retaining groove for the disc D, and a roller 60 is disposed in the retaining groove. Since the guide arm 50 is configured as such, with the movement of the lever arm 44, the guide arm rocks within the chassis case 2 so that the disc D can be loaded into apparatus.

On the other hand, as shown in FIG. 31, the lever arm 44 for transmitting a driving force to the guide arm 50 is composed of a slide piece 44A formed with a through-hole 44a for rotatably journaling the pivot pin 50 of the guide arm 59, locking claws 44b, and a downwardly swelled protrusion 44c; and a supporting piece 44B formed with a through-hole 44d to which the follower pin 57 is to be fixed, and a guide groove 44f having slits 44e formed at its sides. Also, the lever arm has a cutout portion 44h formed in such a manner to face the guide groove 44f.

When the locking claws 44b of the thus formed slide piece 44A are inserted through the cutout portion 44h of the supporting piece and the slide piece 44A is slightly sled forwardly, the locking claws 44b are locked to the slits 44e, and the locking protrusion 44c engages the through-hole 44g of the supporting piece 44B, which integrates the slide piece and the supporting piece into one, as shown in FIG. 32. Thereby, the slide piece A and the slide piece 44B become extendable or retractable to or from the other, but a reference length of the lever arm is locked in a state in which the locking protrusion 44c engages the through-hole 44g. With this configuration, there is a case that the disc D being loaded is pulled back in the unloading direction. In this case, when a load above a predetermined value is applied to the guide arm 50, the locked state can be released to prevent damage to the leave arm 44 and the driving mechanism for driving the lever arm.

FIGS. 33 to 37 show operation aspects of the guide arm 50. These operation aspects will be described below in such a manner to correspond to the operation aspects of the follower pin 53 guided by the cam groove 43c of the main rack body 43. FIG. 33 shows a state that the disc D is inserted into the disc apparatus 1 by an operator. This state is an initial state in which the disc D is pushed back at the front end in its loaded direction to rock the disc supporting arm 17 rearwardly and the first link arm 21 actuates the limit switch 28 to initiate the operation of the driving mechanism C. Accordingly, the main rack body 43 is located at a foremost end as shown in FIG. 33, and the follower pin 57 of the lever arm 44 is located at a rear end of the guide groove 43e.

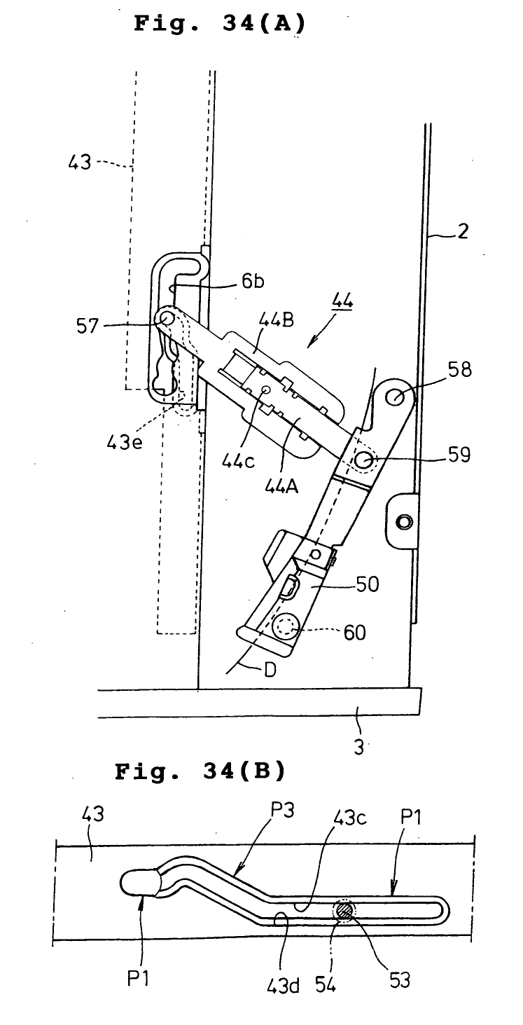

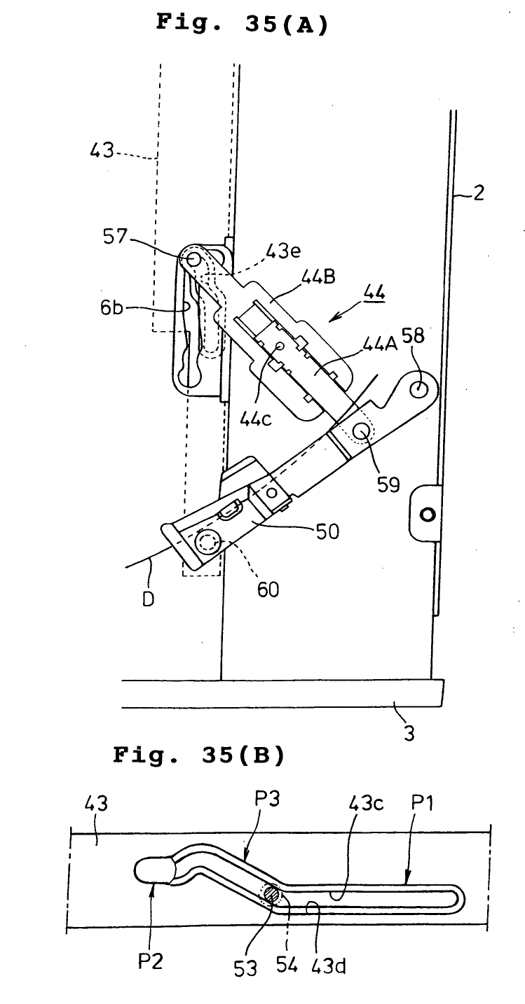

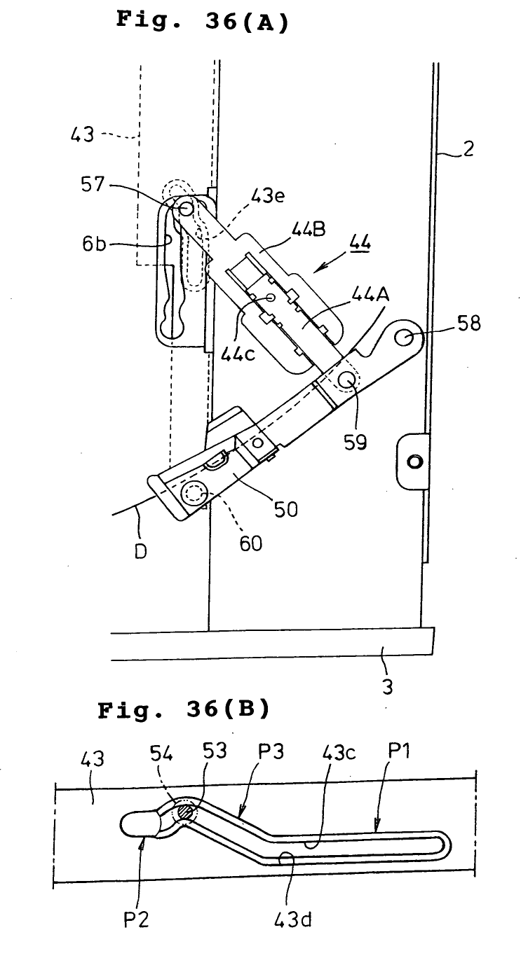

When the driving mechanism C begins to operate in this state, the main rack body 43 begins to retreat as shown in FIG. 34. At this time, the follower pin 57 is pinched between the slope at the rear end of the guide groove 43e and the sidewall of the guide slit 6b. Therefore, with advancement of the main rack body 43, the follower pin 57 also retreats, and the lever arm 44 is drawn to rock the guide arm 50 to retain the disc D by the disc supporting arm 17, thereby starting the loading of the disc D. At this time, the follower pin 53 is moving in a horizontal portion at the lower portion P1 of the cam groove 43c, so its height does not change.

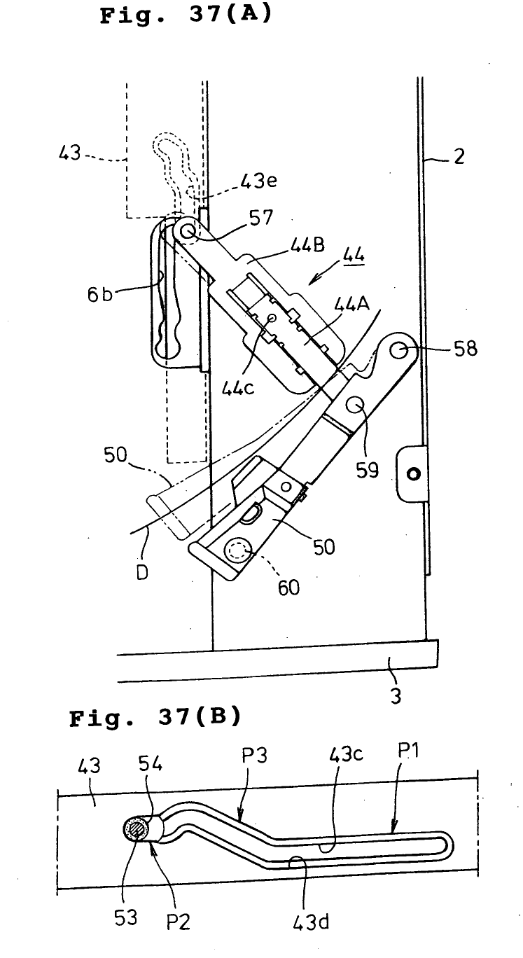

FIG. 35 shows a state in which the main rack body 43 retreats further and the follower pin 57 has reached the apex of the guide slit 6b. This state is a state in which the disc D continues to be loaded by rocking of the guide arm 50 and the center hole Da of the disc D had reached the position which coincides with the clamping head 7. At this time, the follower pin 53 begins to ascend at a rising gradient along the oblique portion P3 of the cam groove 43c.

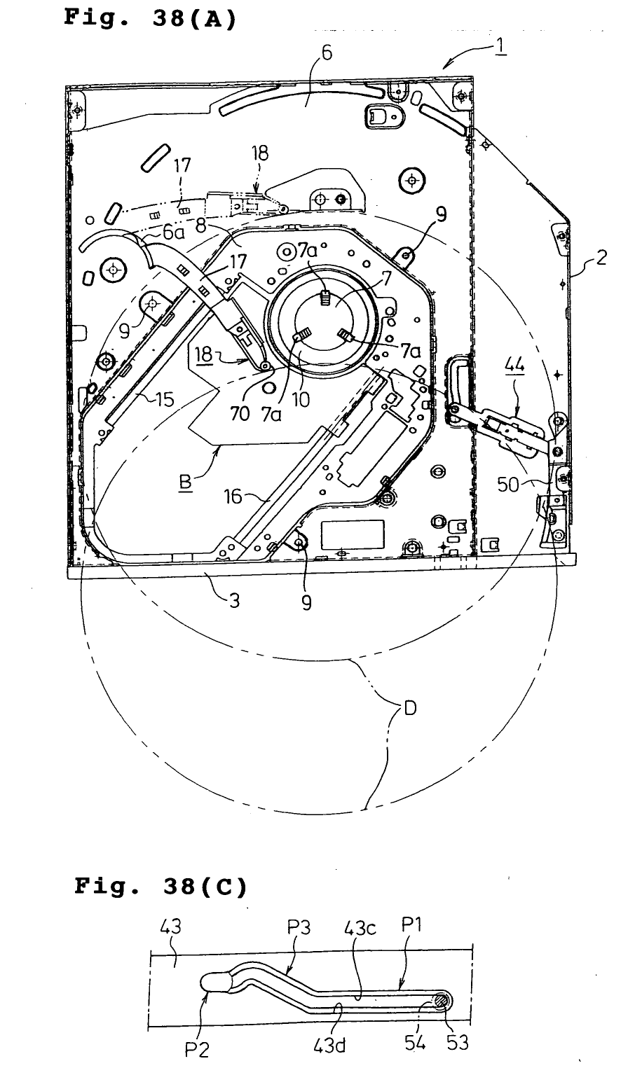

FIG. 36 shows a state in which the main rack body 43 slightly retreats from the position in FIG. 35. In this state, the follower pin 57 has been press-fitted into the transverse groove at the apex of the guide slit 6b by the guide groove 43e. At this time, the follower pin 53 reaches the apex of the oblique portion P3 of the cam groove 43c, thereby completing clamping of the center hole Da of the disc D by the clamping head 7.

FIG. 37 shows a state in which the main rack body 43 has reached a final position. In the course from FIG. 36 to FIG. 37, the follower pin 57 is further pushed into a transverse groove at the apex of the guide slit 6b by the longitudinal groove at the front end of the guide groove 43e. Thereby, the guide groove 50 retreats slightly from the position indicated by an imaginary line in FIG. 37, thereby releasing the retainment of the disc D. At this time, the follower pin 53 descends from the apex of the cam groove 43c to the higher portion P2, which enables rotational driving of the disc D.

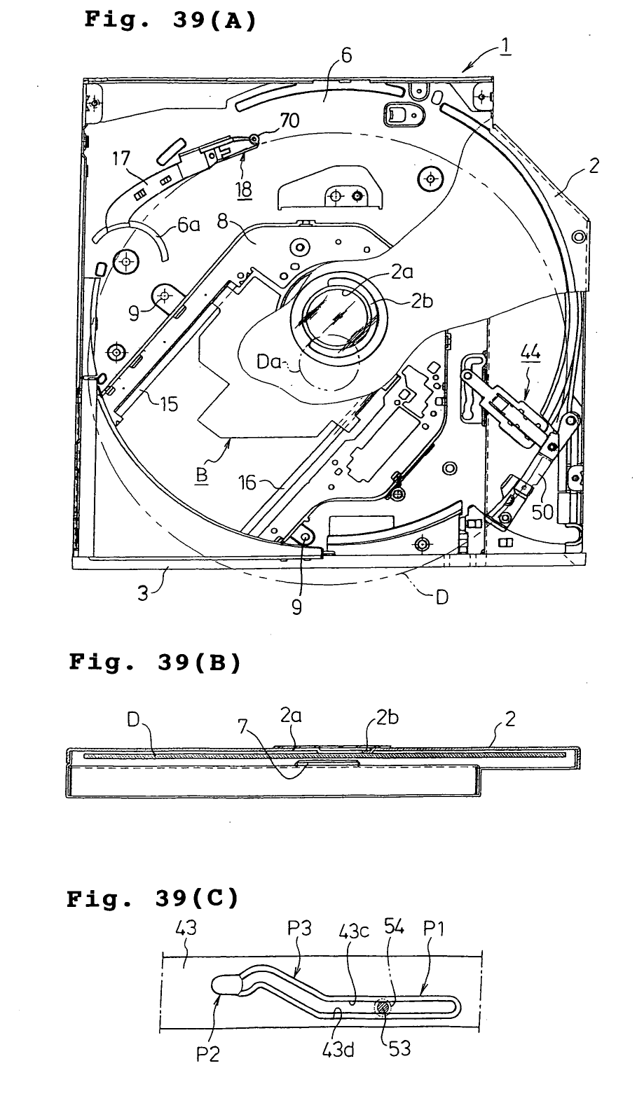

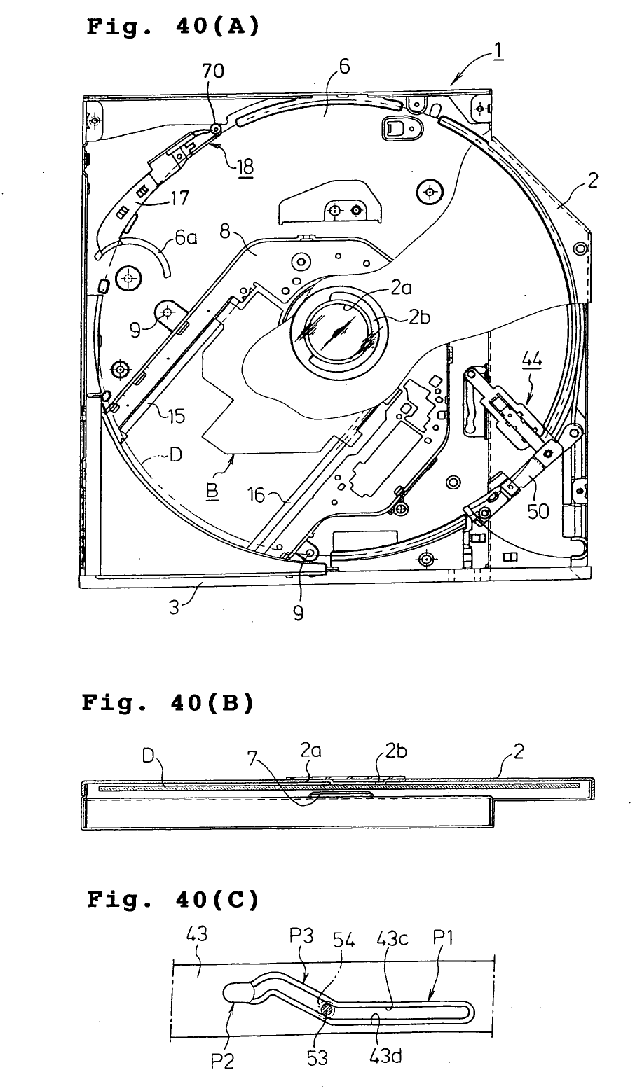

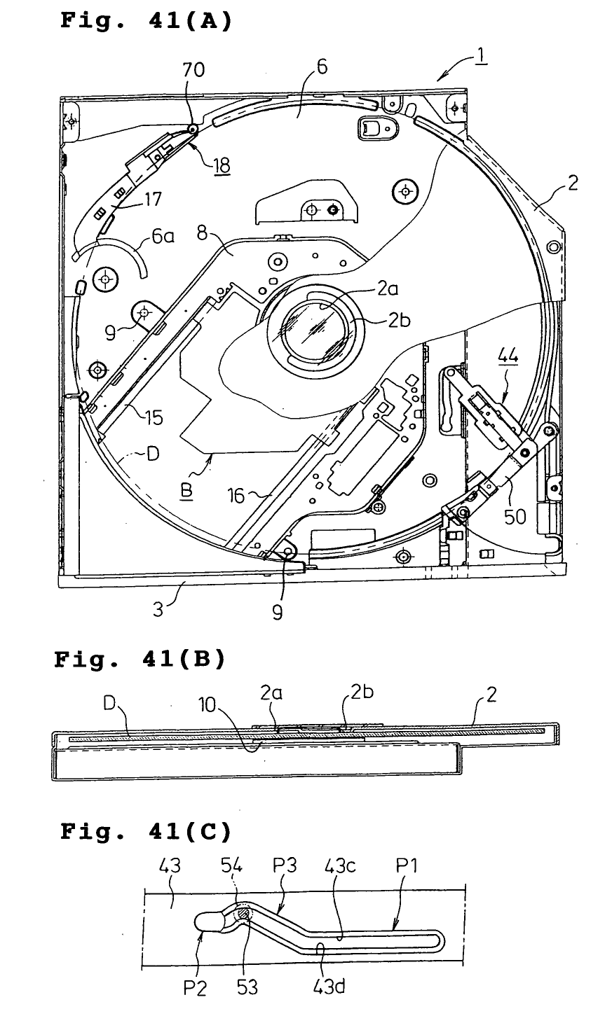

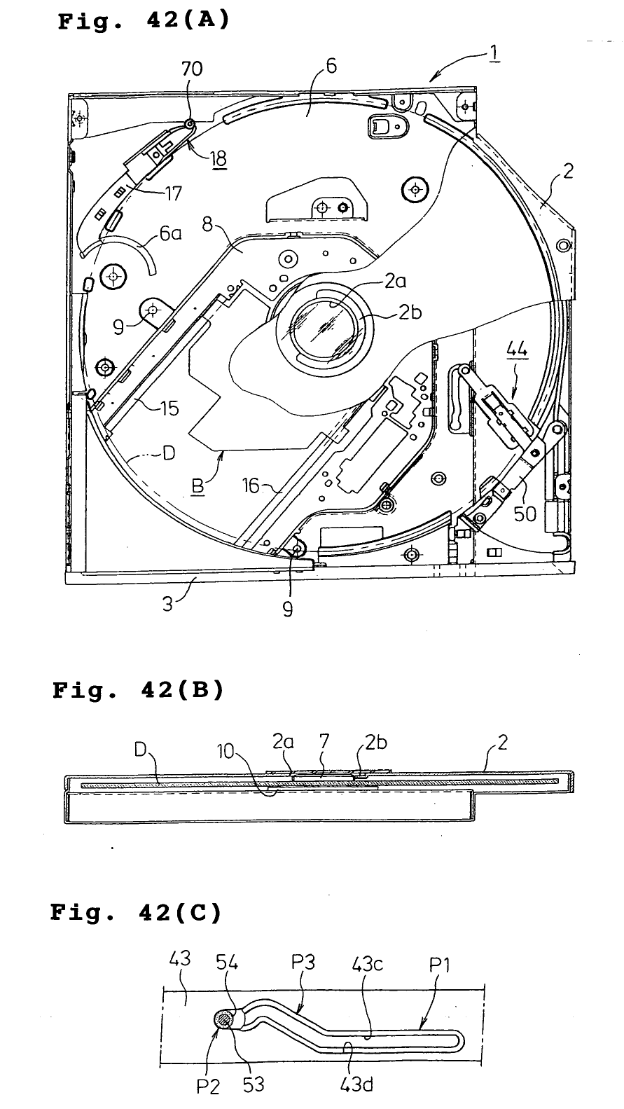

FIGS. 38 to 42 show a state in which the disc supporting arm 17 and the guide arm 50 drives in synchronization with each other, and this state corresponds to the description of the steps of Fugs. 33 to 37.

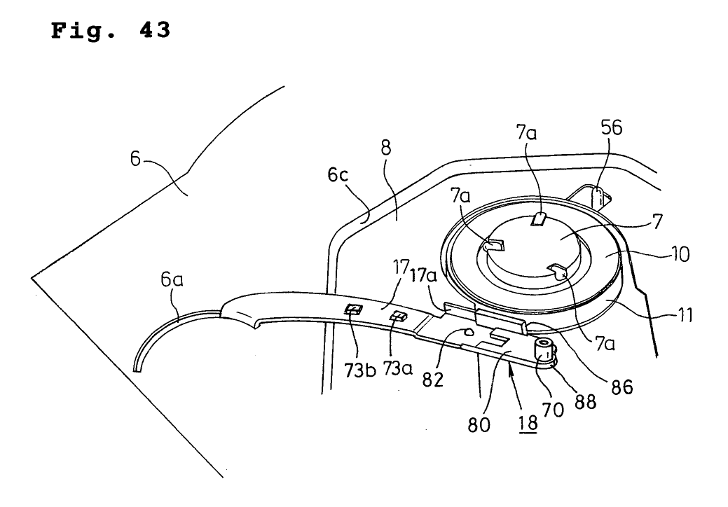

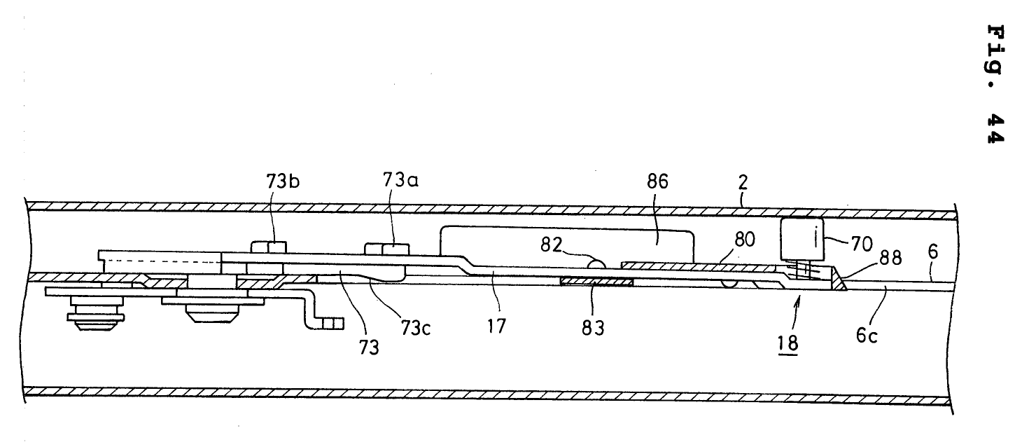

The disc apparatus of the present invention is configured as described above. In this configuration, in the standby state for loading of the disc D into the apparatus, as shown in FIG. 43, the disc supporting arm 17 rocks to the forefront end and is stationary there, and the frame member 8 descends slightly from the base panel 6. In this state, the slope 73c of the slider 73 deviates from the base panel 6. Therefore, as shown in FIG. 44, the compression coil spring 72 biasing the supporting roller 70 pushes the supporting roller 70 against the rear surface of the top plate of the chassis case 2, and the leading end of the disc supporting arm 17 is pushed down by the reaction of the compression coil spring 72.

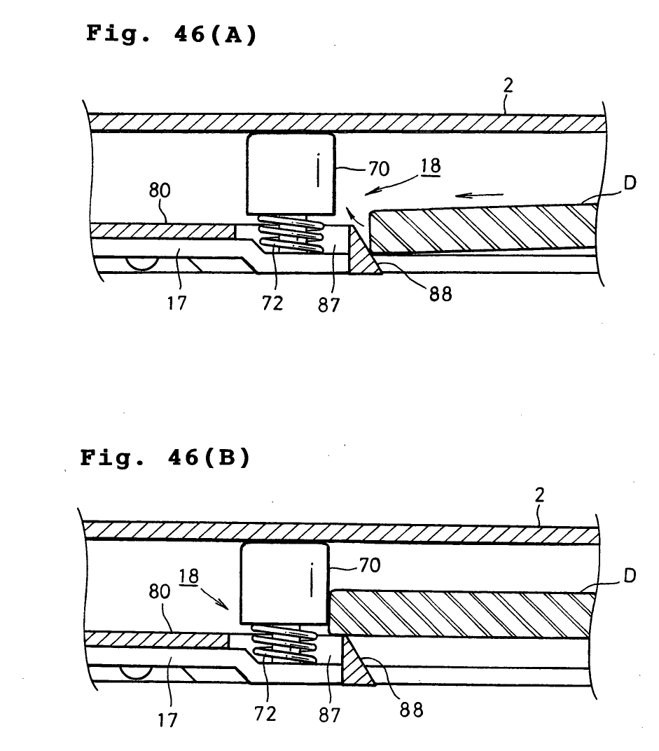

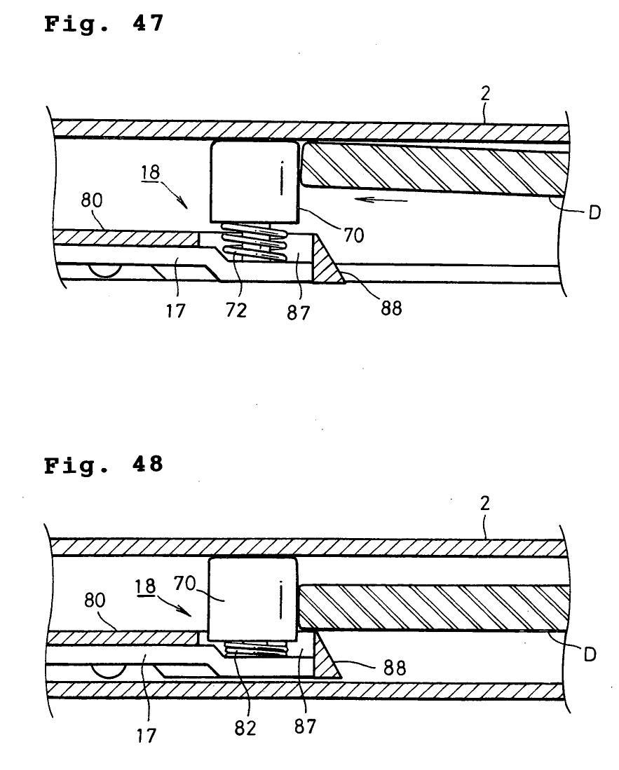

Accordingly, the leading end of the scooping surface 88 of the holder 80 of the disc supporting portion 18 at the leading end of the disc supporting arm 17 enters the opening 6c of the base panel 6. Thereby, as shown in FIG. 46A, the disc D whose front end approaches downwardly, is prevented form entering the rear surface of the leading end of the disc supporting arm 17. Also, the front end of the disc D abutting on the scooping surface 88 is guided along the slope with a rising gradient to approach enter the apparatus, and as shown in FIG. 46B, is received by the supporting roller 70, and is stably retained at the front end of the disc supporting portion 18. Also, as shown in FIG. 47, the disc D whose front end approaches upwardly, is abutted on and received by the head of the supporting roller 70, which is biased to the rear face of the top plate of the chassis case 2 and is contacted therewith.

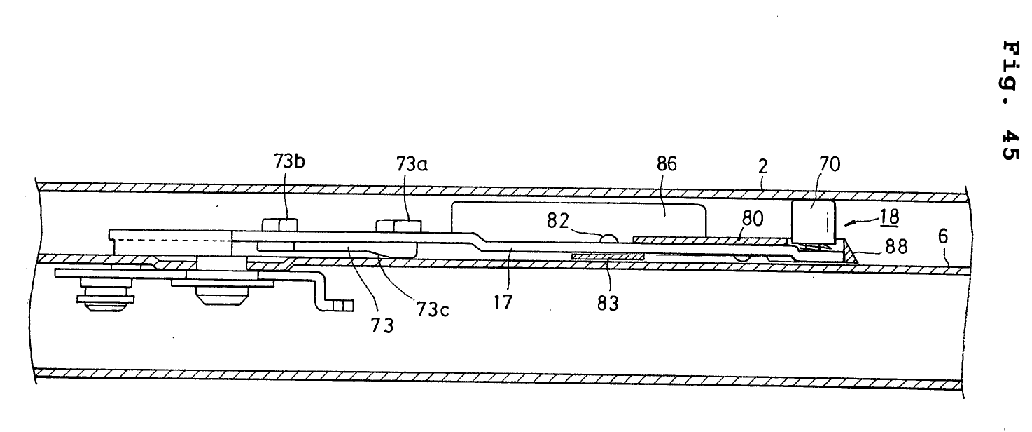

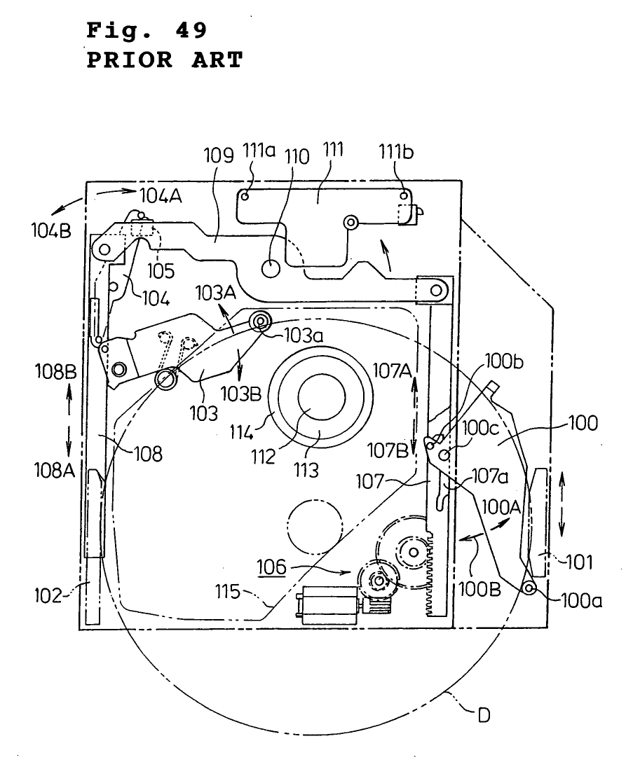

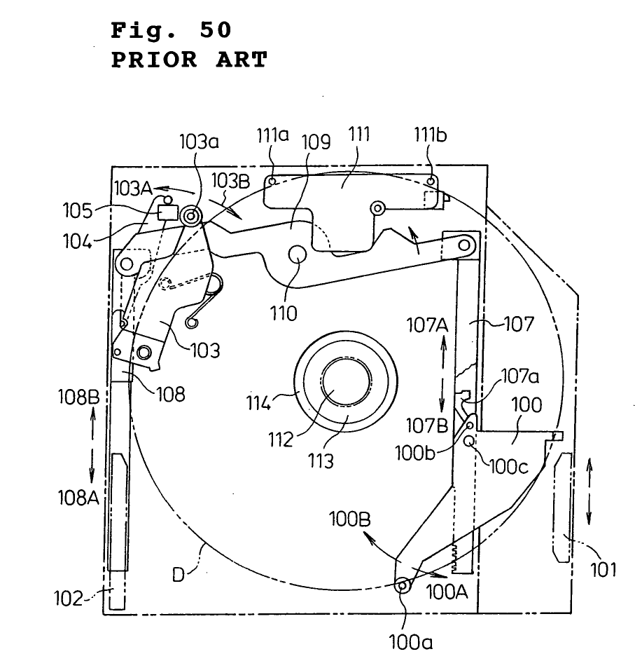

When the disc D enter the apparatus as such to rock the leading end of the disc supporting arm 17 rearwardly, the slope 73c of the slider 73 rides on the base panel 6 as shown in FIG. 45. Then, since the leading end of the disc supporting arm 17 ascends as shown in FIG. 48 by the action of the slope 73c, the disc D can be guided into the apparatus while being maintained at a position where it does not contact the clamping head 7.

As described above, according to the present invention, even when a front end of a disc inserted through a slot of a bezel by an operator is inclined upwardly or downwardly, the frond end can be surely captured, causes for malfunction of the apparatus and damage to the disc can be eliminated, and a disc apparatus with improved operability and reliability can be provided.

What is claimed is:

1. A disc apparatus comprising a disc supporting arm, wherein in a disc loading operation, the disc supporting arm guides a disc into the disc apparatus by supporting a front end of the disc in a disc loading direction, and in a disc unloading operation, the disc supporting arm pushes a disc out of the disc apparatus by supporting a rear end of the disc in a disc unloading direction, and
wherein a leading end of the disc supporting arm is provided with a normally upwardly biased supporting portion for supporting the disc.

2. The disc apparatus according to claim 1,
wherein a scooping surface for guiding the disc is formed at the leading end of the supporting portion.

3. The disc apparatus according to claim 1,
wherein as the disc supporting arm rocks, the leading end of the disc supporting arm moves up and down.

4. The disc apparatus according to claim 1,
wherein when the disc supporting arm is in a standby state for loading the disc, the leading end of the disc supporting arm descends by a reaction against a biasing force of the supporting portion.
